(19) United States
(12) Patent Application Publication
(10) Pub. No.: US 2014/0353543 A1
(43) Pub. Date: Dec. 4, 2014

(54) THERMALLY CONDUCTIVE POLYMER COMPOSITIONS WITH LASER DIRECT STRUCTURING FUNCTION

(71) Applicant: SABIC Global Technologies B.V., Bergen op Zoom (NL)

(72) Inventors: Tong Wu, Shanghai (CN); Mingcheng Guo, Shanghai (CN); Jiwen Wang, Shangai (CN); Yaqin Zhang, Shanghai (CN); Yuxian An, Shanghai (CN)

(73) Assignee: SABIC Global Technologies B.V., Bergen op Zoom (NL)

(21) Appl. No.: 14/295,551

(22) Filed: Jun. 4, 2014

Related U.S. Application Data
(60) Provisional application No. 61/830,941, filed on Jun. 4, 2013.
(60) Provisional application No. 61/922,064, filed on Dec. 30, 2013.

(51) Int. Cl. C09K 5/14

(52) U.S. Cl. CPC C09K 5/14
USPC 252/75

(57) ABSTRACT

Disclosed herein are methods and compositions of blended polyamide compositions with improved thermal conductivity. The resulting blended polymer compositions, comprising one or more polyamide polymers, one or more thermally conductive fillers, and a laser direct structuring additive, wherein the blended polymer composition has improved thermal conductivity.

### CROSS REFERENCE TO RELATED PATENT APPLICATION

This application claims priority to U.S. Patent Application No. 61/830,941 filed Jun. 4, 2013 and U.S. Patent Application No. 61/922,064 filed Dec. 30, 2013, each of which is herein incorporated by reference in its entirety.

### BACKGROUND

Decreasing the dimensions and weight of components as well as increasing performance in portable electronics is a key market demand. Laser direct structuring technology is increasingly used to satisfy these needs and allows production of materials with ultra-fine precision, high reliability, improved miniaturization, and great flexibility when changing and improving functionality of the target portable electronic product. However, the reduction in size of electronic devices results in greater heat retention which can degrade device performance. Thermally conductive materials are typically used to dissipate heat in many devices such as, for example, LED lamps, e-motors, circuits, processors and coil bobbins. However, there remains a need for suitable polymer compositions that have improved thermal conductivity, while retaining required properties of laser direct structure activation, strength, and flow.

Accordingly, there is a growing need for novel thermally conductive polymer compositions comprising laser direct structuring additives which provide superior heat dissipation, strength, and flow.

### SUMMARY

The present disclosure satisfies these and other needs by providing ultrahigh performance thermoplastic polymer compositions which integrated thermally conductivity performance with laser direct structuring function, thus greatly expanding the scope of laser direct structuring technology.

In one aspect, the present disclosure pertains to blended thermoplastic compositions comprising: a) from about 30 wt % to about 90 wt % of at least one polymer component; b) from about 9 wt % to about 69.95 wt % of a thermally conductive filler; and c) from about 0.05 wt % to about 20 wt % of a laser direct structuring additive; wherein the combined weight percent value of all components does not exceed about 100 wt %; wherein all weight percent values are based on the total weight of the composition; wherein a molded sample of the blended thermoplastic composition has a through plane thermal conductivity of at least about 0.40 W/mK when determined in accordance with ASTM E1461; and wherein a molded sample of the blended thermoplastic composition exhibits a plating index value of at least about 0.5.

In one aspect, the present disclosure pertains to blended thermoplastic compositions comprising: from about 50 wt % to about 95 wt % of a polyamide polymer; from about 4 wt % to about 49.95 wt % of a thermally conductive filler; and from about 0.05 wt % to about 20 wt % of a laser direct structuring additive; wherein the composition has a through plane thermal conductivity of at least about 0.45 W/mK when determined in accordance with ASTM E1461, and exhibits a plating index value of at least about 0.5. In various further aspects, the disclosure relates to articles comprising the disclosed compositions.

In various further aspects, the disclosure relates to articles comprising the disclosed compositions.

In various further aspects, the disclosure relates to methods of improving the thermal conductivity properties of blended thermoplastic compositions.

While aspects of the present disclosure can be described and claimed in a particular statutory class, such as the system statutory class, this is for convenience only and one of skill in the art will understand that each aspect of the present disclosure can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

### DETAILED DESCRIPTION

The present disclosure can be understood more readily by reference to the following detailed description of the disclosure and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present disclosure, example methods and materials are now described.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

All publications mentioned herein are incorporated herein by reference to disclose and describe the methods and/or materials in connection with which the publications are cited.

### DEFINITIONS

It is also to be understood that the terminology used herein is for the purpose of describing particular aspects only and is not intended to be limiting. As used in the specification and in the claims, the term “comprising” can include the embodiments “consisting of” and “consisting essentially of” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “a polyamide polymer” includes mixtures of two or more polyamide polymers.

As used herein, the term “combination” is inclusive of blends, mixtures, alloys, reaction products, and the like.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally substituted alkyl” means that the alkyl group can or cannot be substituted and that the description includes both substituted and unsubstituted alkyl groups.

As used herein, the term “effective amount” refers to an amount that is sufficient to achieve the desired modification of a physical property of the composition or material. For example, an “effective amount” of a thermally conductive filler refers to an amount that is sufficient to achieve the desired improvement in the property modulated by the formulation component, e.g. achieving the desired level of thermal conductivity. The specific level in terms of wt % in a composition required as an effective amount will depend upon a variety of factors including the amount and type of polyamide, amount and type of laser direct structure additive, amount and type of thermally conductive filler, and end use of the article made using the composition.

Disclosed are the components to be used to prepare the compositions of the disclosure as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the disclosure. Thus, if there are a variety of additional steps that can be performed it is understood that each of these additional steps can be performed with any specific aspect or combination of aspects of the methods of the disclosure.

References in the specification and concluding claims to parts by weight of a particular element or component in a composition or article, denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

As used herein the terms “weight percent,” “wt %,” and “wt. %,” which can be used interchangeably, indicate the percent by weight of a given component based on the total weight of the composition, unless otherwise specified. That is, unless otherwise specified, all wt % values are based on the total weight of the composition. It should be understood that the sum of wt % values for all components in a disclosed composition or formulation are equal to 100.

Compounds are described using standard nomenclature. For example, any position not substituted by any indicated group is understood to have its valence filled by a bond as indicated, or a hydrogen atom. A dash (“-”) that is not between two letters or symbols is used to indicate a point of attachment for a substituent. For example, —CHO is attached through carbon of the carbonyl group. Unless defined otherwise, technical and scientific terms used herein have the same meaning as is commonly understood by one of skill in the art to which this disclosure belongs.

The term “alkyl group” as used herein is a branched or unbranched saturated hydrocarbon group of 1 to 24 carbon atoms, such as methyl, ethyl, n propyl, isopropyl, n butyl, isobutyl, t butyl, pentyl, hexyl, heptyl, octyl, decyl, tetradecyl, hexadecyl, eicosyl, tetracosyl and the like. A “lower alkyl” group is an alkyl group containing from one to six carbon atoms.

The term “aryl group” as used herein is any carbon-based aromatic group including, but not limited to, benzene, naphthalene, etc. The term “aromatic” also includes “heteroaryl group,” which is defined as an aromatic group that has at least one heteroatom incorporated within the ring of the aromatic group. Examples of heteroatoms include, but are not limited to, nitrogen, oxygen, sulfur, and phosphorus. The aryl group can be substituted or unsubstituted. The aryl group can be substituted with one or more groups including, but not limited to, alkyl, alkynyl, alkenyl, aryl, halide, nitro, amino, ester, ketone, aldehyde, hydroxy, carboxylic acid, or alkoxy.

The term “aralkyl” as used herein is an aryl group having an alkyl, alkynyl, or alkenyl group as defined above attached to the aromatic group. An example of an aralkyl group is a benzyl group.

The term “carbonate group” as used herein is represented by the formula OC(O)OR, where R can be hydrogen, an alkyl, alkenyl, alkynyl, aryl, aralkyl, cycloalkyl, halogenated alkyl, or heterocycloalkyl group described above.

The term “organic residue” defines a carbon containing residue, i.e., a residue comprising at least one carbon atom, and includes but is not limited to the carbon-containing groups, residues, or radicals defined hereinabove. Organic residues can contain various heteroatoms, or be bonded to another molecule through a heteroatom, including oxygen, nitrogen, sulfur, phosphorus, or the like. Examples of organic residues include but are not limited alkyl or substituted alkyls, alkoxy or substituted alkoxy, mono or di-substituted amino, amide groups, etc. Organic residues can preferably comprise 1 to 18 carbon atoms, 1 to 15, carbon atoms, 1 to 12 carbon atoms, 1 to 8 carbon atoms, 1 to 6 carbon atoms, or 1 to 4 carbon atoms. In a further aspect, an organic residue can comprise 2 to 18 carbon atoms, 2 to 15, carbon atoms, 2 to 12 carbon atoms, 2 to 8 carbon atoms, 2 to 4 carbon atoms, or 2 to 4 carbon atoms.

A very close synonym of the term “residue” is the term “radical,” which as used in the specification and concluding claims, refers to a fragment, group, or substructure of a molecule described herein, regardless of how the molecule is prepared. For example, a 2,4-dihydroxyphenyl radical in a particular compound has the structure:

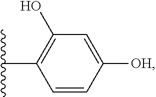 [SMILES: *c1ccc(O)cc1O]

regardless of whether 2,4-dihydroxyphenyl is used to prepare the compound. In some embodiments the radical (for example an alkyl) can be further modified (i.e., substituted alkyl) by having bonded thereto one or more “substituent radicals.” The number of atoms in a given radical is not critical to the present disclosure unless it is indicated to the contrary elsewhere herein.

“Organic radicals,” as the term is defined and used herein, contain one or more carbon atoms. An organic radical can have, for example, 1-26 carbon atoms, 1-18 carbon atoms, 1-12 carbon atoms, 1-8 carbon atoms, 1-6 carbon atoms, or 1-4 carbon atoms. In a further aspect, an organic radical can have 2-26 carbon atoms, 2-18 carbon atoms, 2-12 carbon atoms, 2-8 carbon atoms, 2-6 carbon atoms, or 2-4 carbon atoms. Organic radicals often have hydrogen bound to at least some of the carbon atoms of the organic radical. One example, of an organic radical that comprises no inorganic atoms is a 5,6,7,8-tetrahydro-2-naphthyl radical. In some embodiments, an organic radical can contain 1-10 inorganic heteroatoms bound thereto or therein, including halogens, oxygen, sulfur, nitrogen, phosphorus, and the like. Examples of organic radicals include but are not limited to an alkyl, substituted alkyl, cycloalkyl, substituted cycloalkyl, mono-substituted amino, di-substituted amino, acyloxy, cyano, carboxy, carboalkoxy, alkylcarboxamide, substituted alkylcarboxamide, dialkylcarboxamide, substituted dialkylcarboxamide, alkylsulfonyl, alkylsulfinyl, thioalkyl, thiohaloalkyl, alkoxy, substituted alkoxy, haloalkyl, haloalkoxy, aryl, substituted aryl, heteroaryl, heterocyclic, or substituted heterocyclic radicals, wherein the terms are defined elsewhere herein. A few non-limiting examples of organic radicals that include heteroatoms include alkoxy radicals, trifluoromethoxy radicals, acetoxy radicals, dimethylamino radicals and the like.

As used herein, the terms “number average molecular weight” or “Mₙ” can be used interchangeably, and refer to the statistical average molecular weight of all the polymer chains in the sample and is defined by the formula:

$${M}_{n} = \frac{\sum {N}_{i} {M}_{i}}{\sum {N}_{i}} , \\ {M}_{n} = \frac{\sum {N}_{i} {M}_{i}}{\sum {N}_{i}} ,$$

where Mᵢ is the molecular weight of a chain and Nᵢ is the number of chains of that molecular weight. Mₙ can be determined for polymers, e.g., polycarbonate polymers, by methods well known to a person having ordinary skill in the art using molecular weight standards, e.g. polycarbonate standards or polystyrene standards, preferably certified or traceable molecular weight standards.

$${M}_{n} = \frac{\sum {N}_{i} {M}_{i}}{\sum {N}_{i}} ,$$

As used herein, the terms “weight average molecular weight” or “Mw” can be used interchangeably, and are defined by the formula:

$${M}_{w} = \frac{\sum {N}_{i} {M}_{i}}{\sum {N}_{i}} ,$$

where Mᵢ is the molecular weight of a chain and Nᵢ is the number of chains of that molecular weight. Compared to Mₙ, M_{w} takes into account the molecular weight of a given chain in determining contributions to the molecular weight average. Thus, the greater the molecular weight of a given chain, the more the chain contributes to the M_{w}. M_{w} can be determined for polymers, e.g. polycarbonate polymers, by methods well known to a person having ordinary skill in the art using molecular weight standards, e.g. polycarbonate standards or polystyrene standards, preferably certified or traceable molecular weight standards.

As used herein, the terms “polydispersity index” or “PDI” can be used interchangeably, and are defined by the formula:

$$PDI = \frac{{M}_{w}}{{M}_{n}} .$$

The PDI has a value equal to or greater than 1, but as the polymer chains approach uniform chain length, the PDI approaches unity.

The terms “residues” and “structural units”, used in reference to the constituents of the polymers, are synonymous throughout the specification.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

### Blended Thermoplastic Compositions

In one aspect, the present disclosure pertains to blended thermoplastic compositions comprising: a) from about 30 wt % to about 90 wt % of at least one polymer component; b) from about 10 wt % to about 70 wt % of a thermally conductive filler; and c) from about 0.05 wt % to about 20 wt % of a laser direct structuring additive; wherein the combined weight percent value of all components does not exceed about 100 wt %; wherein all weight percent values are based on the total weight of the composition; wherein a molded sample of the blended thermoplastic composition has a through plane thermal conductivity of at least about 0.40 W/mK when determined in accordance with ASTM E1461; and wherein a molded sample of the blended thermoplastic composition exhibits a plating index value of at least about 0.5.

In one aspect, the present disclosure pertains to blended thermoplastic compositions comprising: a) from about 30 wt % to about 90 wt % of a polyamide polymer; b) from about 10 wt % to about 70 wt % of a thermally conductive filler; and c) from about 0.05 wt % to about 20 wt % of a laser direct structuring additive; wherein the composition has a through plane thermal conductivity of at least about 0.45 W/mK when determined in accordance with ASTM E1461, and exhibits a plating index value of at least about 0.5.

In a further aspect, the present disclosure pertains to blended thermoplastic compositions comprising: a) from about 20 wt % to about 70 wt % of a polyamide polymer; b) from about 10 wt % to about 55 wt % of a thermally conductive filler; and c) from about 0.05 wt % to about 10 wt % of a laser direct structuring additive; wherein the combined weight percent value of all components does not exceed about 100 wt %; wherein all weight percent values are based on the total weight of the composition; wherein a molded sample of the blended thermoplastic composition has a through plane thermal conductivity of at least about 0.45 W/mK when determined in accordance with ASTM E1461; and wherein a molded sample of the blended thermoplastic composition exhibits a plating index value of at least about 0.5.

In a further aspect, the present disclosure pertains to blended thermoplastic compositions comprising: a) from about 30 wt % to about 60 wt % of a polyamide polymer; b) from about 10 wt % to about 40 wt % of a thermally conductive filler; and c) from about 1 wt % to about 5 wt % of a laser direct structuring additive; wherein the combined weight percent value of all components does not exceed about 100 wt %; wherein all weight percent values are based on the total weight of the composition; wherein a molded sample of the blended thermoplastic composition has a through plane thermal conductivity of at least about 0.45 W/mK when determined in accordance with ASTM E1461; and wherein a molded sample of the blended thermoplastic composition exhibits a plating index value of at least about 0.5.

In a further aspect, the present disclosure pertains to blended thermoplastic compositions comprising: a) from about 30 wt % to about 90 wt % of a polyamide polymer; b) from about 10 wt % to about 70 wt % of a thermally conductive filler; and c) from about 0.05 wt % to about 20 wt % of a laser direct structuring additive; wherein the combined weight percent value of all components does not exceed about 100 wt %; wherein all weight percent values are based on the total weight of the composition; wherein a molded sample of the blended thermoplastic composition has a through plane thermal conductivity of at least about 0.50 W/mK when determined in accordance with ASTM E1461; and wherein a molded sample of the blended thermoplastic composition exhibits a plating index value of at least about 0.7.

In a further aspect, the present disclosure pertains to blended thermoplastic compositions comprising: a) from about 20 wt % to about 70 wt % of a polyamide polymer; from about 10 wt % to about 55 wt % of a thermally conductive filler; and c) from about 0.05 wt % to about 10 wt % of a laser direct structuring additive; wherein the combined weight percent value of all components does not exceed about 100 wt %; wherein all weight percent values are based on the total weight of the composition; wherein a molded sample of the blended thermoplastic composition has a through plane thermal conductivity of at least about 0.50 W/mK when determined in accordance with ASTM E1461; and wherein a molded sample of the blended thermoplastic composition exhibits a plating index value of at least about 0.7.

In a further aspect, the present disclosure pertains to blended thermoplastic compositions comprising: a) from about 30 wt % to about 60 wt % of a polyamide polymer; b) from about 10 wt % to about 40 wt % of a thermally conductive filler; and c) from about 1 wt % to about 5 wt % of a laser direct structuring additive; wherein the combined weight percent value of all components does not exceed about 100 wt %; wherein all weight percent values are based on the total weight of the composition; wherein a molded sample of the blended thermoplastic composition has a through plane thermal conductivity of at least about 0.50 W/mK when determined in accordance with ASTM E1461; and wherein a molded sample of the blended thermoplastic composition exhibits a plating index value of at least about 0.7.

In various aspects, the present disclosure pertains to blended thermoplastic compositions, wherein a molded sample of the blended thermoplastic composition has a through plane thermal conductivity of at least about 0.45 W/mK when determined in accordance with ASTM E1461. In a further aspect, a molded sample of the blended thermoplastic composition has a through plane thermal conductivity of at least about 0.50 W/mK when determined in accordance with ASTM E1461. In a still further aspect, a molded sample of the blended thermoplastic composition has a through plane thermal conductivity from about 0.40 W/mK to about 25 W/mK when determined in accordance with ASTM E1461. In a yet further aspect, a molded sample of the blended thermoplastic composition has a through plane thermal conductivity from about 0.45 W/mK to about 23 W/mK when determined in accordance with ASTM E1461. In an even further aspect, a molded sample of the blended thermoplastic composition has a through plane thermal conductivity from about 0.50 W/mK to about 20 W/mK when determined in accordance with ASTM E1461.

In various aspects, the present disclosure pertains to blended thermoplastic compositions, wherein a molded sample of the blended thermoplastic composition exhibits a plating index value of at least about 0.6. In a further aspect, a molded sample of the blended thermoplastic composition exhibits a plating index value of at least about 0.7. In a still further aspect, a molded sample of the blended thermoplastic composition exhibits a plating index value from about 0.5 to about 1.5. In a yet further aspect, a molded sample of the blended thermoplastic composition exhibits a plating index value from about 0.6 to about 1.2. In an even further aspect, a molded sample of the blended thermoplastic composition exhibits a plating index value from about 0.7 to about 1.9.

In various aspects, the compositions of the present disclosure further comprise an additive selected from coupling agents, antioxidants, mold release agents, UV absorbers, light stabilizers, heat stabilizers, lubricants, plasticizers, pigments, dyes, colorants, anti-static agents, nucleating agents, anti-drip agents, acid scavengers, and combinations of two or more of the foregoing. In a further aspect, compositions of the present disclosure further comprise at least one additive selected from a flame retardant, a colorant, a primary anti-oxidant, and a secondary anti-oxidant.

### Polymer Component

In one aspect, the blended thermoplastic compositions of the present disclosure comprise at least one polymer component present in an amount form about 30 wt % to about 90 wt %. In various aspects, the polymer component comprises a polypropylene, a polyethylene, an ethylene-based copolymer, a polycarbonate, a polyamide, a polyester, a polyoxymethylene (“POM”), a liquid crystal polymer (“LCP”), a polyphenylene sulfide (“PPS”), a polyphenylene ether (“PPE”), a polystyrene, a acrylonitrile-butadiene-styrene terpolymer (“ABS”), an acrylic polymer, a polyetherimide (“PEI”), a polyurethane, a polyethersulphone (“PES”), a polyetheretherketone (“PEEK”), a thermoset polymer, or combinations thereof. In a further aspect, the polymer component comprises a polypropylene, a polyethylene, an ethylene-based copolymer, a polycarbonate, a polyamide, a polyester, a polyoxymethylene (“POM”), a liquid crystal polymer (“LCP”), a polyphenylene sulfide (“PPS”), a polyphenylene ether (“PPE”), a polystyrene, a acrylonitrile-butadiene-styrene terpolymer (“ABS”), an acrylic polymer, a polyetherimide (“PEI”), a polyurethane, a polyethersulphone (“PES”), or a polyetheretherketone (“PEEK”), or combinations thereof. In a still further aspect, the polymer component comprises a thermoset polymer.

In a further aspect, the polymer component is a polyamide. In a still further aspect, the disclosed blended thermoplastic compositions can comprise a polyamide polymer and a polymer selected from polycarbonate, polypropylene, polyethylene, ethylene based copolymer, polycarbonate, polyamide, polyester, polyoxymethylene, liquid crystal, polyphenylene sulfide, polyphenylene ether, polyphenylene oxide-polystyrene blend, polystyrene, high impact modified polystyrene, acrylonitrile-butadiene-styrene, terpolymer, acrylic polymer, polyetherimide, polyurethane, polyetheretherketone, polyether sulfone, and thermoset polymer, or combinations thereof.

In various aspects, the disclosed blended thermoplastic compositions can optionally omit the polyamide polymer and replace it with a polymer selected from polycarbonate, polypropylene, polyethylene, ethylene based copolymer, polycarbonate, polyamide, polyester, polyoxymethylene, liquid crystal, polyphenylene sulfide, polyphenylene ether, polyphenylene oxide-polystyrene blend, polystyrene, high impact modified polystyrene, acrylonitrile-butadiene-styrene, terpolymer, acrylic polymer, polyetherimide, polyurethane, polyetheretherketone, polyether sulfone, and thermoset polymer, or combinations thereof.

In a further aspect, the polyester is a terephthalate polyester. In a still further aspect, the terephthalate polyester comprises a polybutylene terephthalate (“PBT”), a polyethylene terephthalate (“PET”), or a polycyclohexylenedimethylene terephthalate (“PCT”), or combinations thereof. In a yet further aspect, the polyester comprises a blend of at least one polyphenylene oxide and at least one polystyrene.

Polymers such as polycarbonate, polypropylene, polyethylene, ethylene based copolymer, polycarbonate, polyamide, polyester, polyoxymethylene, liquid crystal, polyphenylene sulfide, polyphenylene ether, polyphenylene oxide-polystyrene blend, polystyrene, high impact modified polystyrene, acrylonitrile-butadiene-styrene, terpolymer, acrylic polymer, polyetherimide, polyurethane, polyetheretherketone, polyether sulfone, and thermoset polymer, or combinations thereof, generally known to skilled artisan and are within the scope of the present disclosure. The above thermoplastic polymers are either commercially available or can be readily synthesized by synthetic methods well known to those of skill in the art.

### Polyamide Component

In various aspects, the present disclosure pertains to blended thermoplastic compositions wherein the polymer component comprises a polyamide polymer. In a further aspect, the polyamide polymer present in an amount from about 30 wt % to about 90 wt % of a polyamide polymer.

The term polyamide as used herein is not intended to refer to only a specific polyamide or group of polyamides, but rather refers to any one of the class of compounds containing a repeating chain of amide groups. Polyamides, also known as polyamides, are characterized by the presence of a plurality of amide (—C(O)NH—) groups. In one aspect, a polyamide polymer or material can include any one or more of those polyamide materials disclosed in in U.S. Pat. No. 4,970,272 to Gallucci. In a yet further aspect, the polyamide resin or combination of polyamide resins has a melting point (Tm) greater than or equal to 171° C. In an even further aspect, the polyamide comprises a super tough polyamide, that is, a rubber-toughened polyamide, the composition can or cannot contain a separate impact modifier. Polyamide polymers having a comparatively high content of amine terminal groups can also be used.

Polyamides can be obtained by a number of well-known processes such as those described in U.S. Pat. Nos. 2,071,250, 2,071,251, 2,130,523, and 2,130,948 to Carothers; U.S. Pat. Nos. 2,241,322 and 2,312,966 to Hanford; and U.S. Pat. No. 2,512,606 to Bolton et al. In addition, polyamide resins are commercially available from a variety of sources.

Polyamides are generally derived from the polymerization of organic lactams having from 4 to 12 carbon atoms. In one aspect, lactams are compounds having the formula:

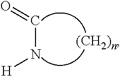

wherein n is an integer from about 3 to about 11. In a further aspect, the lactam is ε-caprolactam having n equal to 5.

Polyamides can also be synthesized from amino acids having from 4 to 12 carbon atoms. In one aspect, amino acids are compounds having the formula:

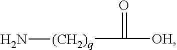

wherein q is an integer from about 3 to about 11. In a further aspect, the amino acid is ε-aminocaproic acid with n equal to 5.

Polyamides can also be polymerized from aliphatic dicarboxylic acids having from 4 to 12 carbon atoms and aliphatic diamines having from 2 to 12 carbon atoms. For example, in one aspect, aliphatic dicarboxylic acids have from about 6 to about 12 carbon atoms in the chain, and exemplary aliphatic dicarboxylic acids include suberic acid, sebacic acid, azelaic acid, adipic acid and the like. In a further aspect, aliphatic diamines are compounds represented by the formula:

H₂N—(CH₂)ᵣ—NH₂,

wherein r is an integer from about 2 to about 12. In a still further aspect, the aliphatic diamine is hexamethylenediamine (H₂N(CH₂)₆NH₂).

In various aspects, the molar ratio of the dicarboxylic acid to the diamine can be about 0.66 to about 1.5. In a further aspect, the molar ratio is greater than or equal to about 0.81. In a still further aspect, the molar ration is greater than or equal to about 0.96. In a yet further aspect, the molar ratio is less than or equal to about 1.22. In an even further aspect, the molar ratio is less than or equal to about 1.04.

Synthesis of polyamideesters can also be accomplished from aliphatic lactones having from 4 to 12 carbon atoms and aliphatic lactams having from 4 to 12 carbon atoms. The ratio of aliphatic lactone to aliphatic lactam can vary widely depending on the desired composition of the final copolymer, as well as the relative reactivity of the lactone and the lactam. In various aspects, the initial molar ratio of aliphatic lactam to aliphatic lactone is about 0.5 to about 4. In a still further aspect, the molar ratio is greater than or equal to about 1. In a still further aspect, the molar ratio is greater than or equal to about 2.

Preparation of suitable polyamides can further include a catalyst or an initiator. Generally, any known catalyst or initiator suitable for the polymerization can be used. Alternatively, the polymerization can be conducted without a catalyst or initiator. For example, in the synthesis of polyamides from aliphatic dicarboxylic acids and aliphatic diamines, no catalyst is required.

For the synthesis of polyamides from lactams, suitable catalysts include water and the omega-amino acids corresponding to the ring-opened (hydrolyzed) lactam used in the synthesis. In various aspects, additional suitable catalysts include metallic aluminum alkylates (MAl(OR)₃H, wherein M is an alkali metal or alkaline earth metal, and R is a C12 alkyl moiety, sodium dihydrobis(2-methoxyethoxy)aluminate, lithium dihydrobis(tert-butoxy)aluminate, aluminum alkylates (e.g. Al(OR)₂R; wherein R is C1-C12 alkyl), N-sodium caprolactam, magnesium chloride or bromide salt of epsilon-caprolactam (MgXC₆H₁₀NO, X=Br or CI), dialkoxy aluminum hydride. In a further aspect, additional suitable initiators include isophthaloybiscaprolactam, N-acetalcaprolactam, isocyanate epsilon-caprolactam adducts, alcohols (R—OH; wherein R is C1-C12 alkyl), diols (HO—R—OH, wherein R C1-C12 alkylene), omega-aminocaproic acids, and sodium methoxide.

The polyamides can also be semi-aromatic polyamides, such as PA4.T, PA6.T, or PA9.T polyamides. As used herein, a “semi-aromatic polyamide” is understood to be a polyamide homo- or copolymer that contains aromatic or semi-aromatic units derived from an aromatic dicarboxylic acid, an aromatic diamine, or an aromatic aminocarboxylic acid, the content of said units being at least 50 mol %. In some cases these semi-aromatic polyamides are blended with small amounts of aliphatic polyamides for better processability. They are available commercially from, e.g., DuPont, Wilmington, Del., USA under the Trade name Zytel HTN; Solvay Advanced Polymers under the Trade name Amodel; or from DSM, Sittard, The Netherlands under the Trade name Stanyl For Tii.

For the synthesis of polyamideesters from lactones and lactams, suitable catalysts include metal hydride compounds, such as a lithium aluminum hydride catalysts having the formula LiAl(H)ₓ(R¹)_{y}, where x is an integer from about 1 to about 4, y is an integer from about 0 to about 3, x+y is equal to 4, and R¹ is selected from C1-C12 alkyl and C1-C12 alkoxy; highly preferred catalysts include LiAl(H)(OR²)₃, wherein R² is selected from the group consisting of C1-C8 alkyl. In a still further, the catalyst is LiAl(H)(OC(CH₃)₃)₃. Other suitable catalysts and initiators include those described above for the polymerization of poly(ε-caprolactam) and poly(ε-caprolactone).

Examples of suitable polyamide polymers useful for use in the disclosed blended thermoplastic compositions of the present include, but are not limited to, polyamide-4, polyamide-6, polyamide-11; polyamide-12, polyamide-4,6, polyamide-6,6, polyamide-3,4, polyamide 6,9, polyamide-6,10, polyamide 6,12, polyamide 6/6T and polyamide 6,6/6T with triamine contents below 0.5 weight percent, polyamide 9T, amorphous polyamide resins, and combinations thereof. Further examples of suitable polyamide polymers useful for use in the disclosed blended thermoplastic compositions of the present include, but are not limited to, PA 6, PA46, PA49, PA410, PA411, PA412, PA413, PA414, PA415, PA416, PA418, PA436, PA 66, PA 69, PA 610, PA 611, PA 612, PA 613, PA 614, PA 615, PA 616, PA 617, PA 618, PA 66/6, PA 6/66/12, PA 6/12, PA 11, PA 12, PA 912, PA 1212, 6T/61, MXD6, MXD6/MXDI, MXD9, MXD10, MXD11, MXD12, MXD13, MXD14, MXD15, MXD16, MXD17, MXD18, MXD36, PACM9, PACM10, PACM11, PACM12, PACM13, PACM14, PACM15, PACM16 PACM17, PACM18, and PACM36. Various further examples of suitable polyamide polymers useful for use in the disclosed blended thermoplastic compositions of the present include, but are not limited to, aliphatic polyamides such as polyamide 6; polyamide 6,6; polyamide 4,6; polyamide 6,9; polyamide 6,10; polyamide 6,12; polyamide 10,10; polyamide 11; polyamide 12; polyamide 6,6/6 copolymer; polyamide 6,6/6,8 copolymer; polyamide 6,6/6,10 copolymer; polyamide 6,6/6,12 copolymer; polyamide 6,6/10 copolymer; polyamide 6,6/12 copolymer; polyamide 6/6,8 copolymer; polyamide 6/6,10 copolymer; polyamide 6/6,12 copolymer; polyamide 6/10 copolymer; polyamide 6/12 copolymer; polyamide 6/6,6/6,10 terpolymer; polyamide 6/6,6/6,9 terpolymer; polyamide 6/6,6/11 terpolymer; polyamide 6/6,6/12 terpolymer; polyamide 6/6,10/11 terpolymer; polyamide 6/6,10/12 terpolymer; and polyamide 6/6,6/PACM (bis-p-[aminocyclohexyl]methane) terpolymer.

In a further aspect, the polyamide polymer comprises a semi-aromatic polyamides such as poly(m-xylene adipamide) (polyamide MXD,6); hexamethylene adipamide/hexamethylene terephthalamide copolyamide (polyamide 6,T/6,6); hexamethylene terephthalamide/2-methylpentamethylene terephthalamide copolyamide (polyamide 6,T/D,T); poly(dodecamethylene terephthalamide) (polyamide 12,T); poly(decamethylene terephthalamide) (polyamide 10,T); decamethylene terephthalamide/decamethylene dodecanoamide copolyamide (10,T/10,12); poly(nonamethylene terephthalamide) (polyamide 9,T); the polyamide of hexamethylene isophthalamide and hexamethylene adipamide (polyamide 6,1/6,6); the polyamide of hexamethylene terephthalamide, hexamethylene isophthalamide, and hexamethylene adipamide (polyamide 6,T16,I/6,6); and copolymers and mixtures of these polymers.

In a further aspect, the polyamide polymer comprises a semi-aromatic polyamide, including one or more homopolymers, copolymers, terpolymers, or higher polymers that are derived from monomers containing aromatic groups. The polyamide polymer can also be a blend of one or more homopolymers, copolymers, terpolymers, or higher polymers that are derived from monomers containing aromatic groups with one or more aliphatic polyamides

Suitable polyamides can be condensation products of dicarboxylic acids or their derivatives and diamines, and/or aminocarboxylic acids, and/or ring-opening polymerization products of lactams. In various aspects, the polyamide polymers can be prepared from terephthalic acid and 4,4′-diaminodicyclohexyl methane, polyamide polymers prepared from azelaic acid, adipic acid and 2,2-bis-(p-aminocyclohexyl)propane, polyamide polymers prepared from adipic acid and metaxylene diamine, and polyamides prepared from terephthalic acid and trimethylhexamethylene diamine. In a further aspect, the dicarboxylic acid monomer is selected from adipic acid, azelaic acid, sebacic acid, dodecanedioic acid, isophthalic acid, and terephthalic acid. In a still further aspect, the diamine monomer is selected from tetramethylenediamine, hexamethylenediamine, octamethylenediamine, nonamethylenediamine, dodecamethylenediamine, 2-methylpentamethylenediamine, 2-methyloctamethylenediamine, trimethylhexamethylenediamine, bis(p-aminocyclohexyl)methane, m-xylylenediamine, and p-xylylenediamine. In a yet further aspect, the polyamide polymer comprises residues derived from an aminocarboxylic acid such as 11-aminododecanoic acid. In an even further aspect the polyamide polymer is comprises residues derived from a lactams such as caprolactam or laurolactam.

In a further aspect, the polyamide polymer comprises a blend of two or polyamide polymers.

In a further aspect, the polyamide polymer used in the blended thermoplastic compositions has a weight average molecular weight from about 10,000 Daltons to about 40,000 Daltons. In a still further aspect, the polyamide polymer used in the blended thermoplastic compositions has a weight average molecular weight from about 15,000 Daltons to about 35,000 Daltons. In a yet further aspect, the polyamide polymer used in the blended thermoplastic compositions has a weight average molecular weight from about 20,000 Daltons to about 30,000 Daltons.

In a further aspect, the polyamide polymer is selected from the polyamide polymer is selected from polyamide-4; polyamide-4,6; polyamide-4,9; polyamide-6; polyamide-6,6; polyamide 6,9; polyamide-6,10; polyamide-6,12; polyamide 10; polyamide 10,10; polyamide 10,12; polyamide 11; polyamide-12; polyamide 12,12; amorphous polyamide resins; polyamide PPA; polyamide 4T; polyamide 6T; polyamide 6/6T; polyamide 6,6/6T; polyamide 9T; or combinations thereof. In a still further aspect, the polyamide polymer is selected from polyamide 4,6; polyamide 6; polyamide 6,6; polyamide 6,12; polyamide 10, and polyamide 10,10. In a yet further aspect, the polyamide polymer is selected from polyamide 9T, polyamide 6; polyamide 6,6; polyamide 10,10; or combinations thereof. In an even further aspect, the polyamide polymer is polyamide 6,6; polyamide 10,10; or combinations thereof. In a still further aspect, the polyamide polymer is selected from polyamide 9T; polyamide 10,10; polyamide 6; polyamide 6,6; or combinations thereof.

In a further aspect, the polyamide polymer is present in an amount from about 30 wt % to about 70 wt %. In a still further aspect, the polyamide polymer is present in an amount from about 30 wt % to about 65 wt %. In yet a further aspect, the polyamide polymer is present in an amount from about 30 wt % to about 60 wt %.

In various aspects, the polyamide polymer has a low viscosity. Polyamide resins having an intrinsic viscosity of up to 400 milliliters per gram (ml/g) can be used, or, more specifically, having a viscosity of 90 to 350 ml/g, or, even more specifically, having a viscosity of 110 to 240 ml/g, as measured in a 0.5 wt % solution in 96 wt % sulfuric acid in accordance with ISO 307.

In various further aspects, the polyamide can have a relative viscosity of up to 6, or, more specifically, a relative viscosity of 1.89 to 5.43, or, even more specifically, a relative viscosity of 2.16 to 3.93. Relative viscosity is determined according to DIN 53727 in a 1 wt % solution in 96 wt % sulfuric acid.

In a further aspect, the polyamide resin comprises a polyamide having an amine end group concentration greater than or equal to 35 microequivalents amine end group per gram of polyamide (μeq/g) as determined by titration with hydrochloric acid. The amine end group concentration can be greater than or equal to 40 μeq/g, more specifically about 40 to about 70 μeq/g Amine end group content can be determined by dissolving the polyamide in a suitable solvent, optionally with heat. The polyamide solution is titrated with 0.01 Normal hydrochloric acid (HCl) solution using a suitable indication method. The amount of amine end groups is calculated based the volume of HCl solution added to the sample, the volume of HCl used for the blank, the molarity of the HCl solution, and the weight of the polyamide sample.

In a further aspect, the polyamide polymer comprises a first polyamide polymer and a second polyamide polymer. In a still further aspect, the first polyamide polymer is selected from polyamide 6 and polyamide 6,6; and wherein the second polyamide polymer is selected from polyamide 10,10; polyamide 10,12; and polyamide 12,12.

In a further aspect, the first polyamide polymer is present in an amount from about 10 wt % to about 90 wt %. In a still further aspect, the first polyamide polymer is present in an amount from about 20 wt % to about 70 wt %. In a yet further aspect, the first polyamide polymer is present in an amount from about 30 wt % to about 60 wt %.

In a further aspect, the second polyamide polymer is present in an amount from about 1 wt % to about 40 wt %. In a still further aspect, the second polyamide polymer is present in an amount from about 5 wt % to about 25 wt %. In a yet further aspect, the second polyamide polymer is present in an amount from about 5 wt % to about 15 wt %.

### Laser Direct Structuring Additive

In addition to the thermoplastic resin, the compositions of the present disclosure also include a laser direct structuring (LDS) additive. The LDS additive is selected to enable the composition to be used in a laser direct structuring process. In an LDS process, a laser beam exposes the LDS additive to place it at the surface of the thermoplastic composition and to activate metal atoms from the LDS additive. As such, the LDS additive is selected such that, upon exposed to a laser beam, metal atoms are activated and exposed and in areas not exposed by the laser beam, no metal atoms are exposed. In addition, the LDS additive is selected such that, after being exposed to laser beam, the etching area is capable of being plated to form conductive structure. As used herein “capable of being plated” refers to a material wherein a substantially uniform metal plating layer can be plated on laser-etched area and show a wide window for laser parameters. This process is different than laser marking wherein the main outcome of laser marking is a color change in the material under the effect of energy radiation. And the key characterization for laser marking is the contrast between the mark and the substrate.

Conversely, for LDS, the goal is the formation of metal seeds on the laser etched surface, and the final metallization layer during the following plating process. Plating rate and adhesion of plated layers are the key evaluation requirements. Color here means the substrate made from these materials itself not the color change under the laser radiation. As such, in addition to enabling the composition to be used in a laser direct structuring process, the LDS additive used in the present disclosure is also selected to help enable the composition to be colored while maintaining physical properties.

According to various aspects of the present disclosure, the laser direct structuring additive can comprise one or more metal oxides, including for example, oxides of chromium, copper, or combinations thereof. These laser direct structuring additives can also be provided having spinel type crystal structures. An exemplary and non-limiting example of a commercially available laser direct structuring additive includes PK3095 black pigment, commercially available from Ferro Corp., USA. PK3095, for example, comprises chromium oxides (Cr₂O₃, Cr₂O₄²⁻, Cr₂O₇²⁻) and oxides of copper (CuO), as determined using XPS. The PK3095 black pigment also has a spinel type crystal structure. Another exemplary commercially available laser direct structuring additive is the Black 1G pigment black 28 commercially available from The Shepherd Color company. The Black 1G pigment black 28 comprises copper chromate and has a pH of about 7.3. The Black 1G pigment also has a spinel type crystal structure.

Current additives for LDS materials are usually spinel based metal oxides (such as copper chromium oxide), organic metal complexes (such as palladium/palladium-containing heavy metal complexes) or copper complexes there are some limitations based on these additives. However, spinel based metal oxides result in a black color. In addition, with organic metal complex, higher loadings are needed to obtain sufficiently dense nucleation for rapid metallization when activated, and these higher amounts adversely affect the mechanical properties of the materials.

LDS additives that enable coloring of the material while retaining mechanical strength of the composition can also be used in the present disclosure. Examples of useful LDS additives include, but are not limited to, a metal oxide-coated filler. In one aspect, the LDS additive is antimony doped tin oxide coating on a mica substrate. Other examples include a coating including a copper containing metal oxide, a titanium containing metal oxide, a tin containing metal oxide, a zinc containing metal oxide, a magnesium containing metal oxide, an aluminum containing metal oxide, a gold containing metal oxide, a silver containing metal oxide, or a combination including at least one of the foregoing metal oxides, and the substrate can be any other mineral, such as silica.

Examples of laser direct structuring additives include, but are not limited to, a metal oxide, a metal-oxide coated filler, and a heavy metal mixture oxide spinel, such as copper chromium oxide spinel; a copper salt, such as copper hydroxide phosphate copper phosphate, copper sulfate, cuprous thiocyanato; organic metal complexes, such as palladium/palladium-containing heavy metal complexes or copper complexes; or a combination including at least one of the foregoing LDS additives. In a further aspect, the laser direct structure additive is a metal oxide selected from a copper-containing metal oxide, a titanium-containing metal oxide, a tin-containing metal oxide, a zinc-containing metal oxide, a magnesium-containing metal oxide, an aluminum-containing metal oxide, a gold-containing metal oxide, and a silver-containing metal oxide, or a combination thereof.

Further non-limiting examples of suitable metal oxide materials that can be used as a laser direct structuring additive include antimony doped tin oxide coating on a mineral substrate, a copper containing metal oxide coating on a mineral substrate, a zinc containing metal oxide coating on a mineral substrate, a tin containing metal oxide coating on a mineral substrate, a magnesium containing metal oxide coating on a mineral substrate, an aluminum containing metal oxide coating on a mineral substrate, a gold containing metal oxide coating on a mineral substrate, a silver containing metal oxide coating on a mineral substrate, or a combination thereof. The mineral substrate can be a variety of mineral materials including silica and mica.

In various aspects, the laser direct structuring (LDS) additive is selected from a heavy metal mixture oxide spinel, a copper salt, or a combination including at least one of the foregoing laser direct structuring additives. In a further aspect, the laser direct structuring (LDS) additive comprises a combination of copper chromium oxide and at least one additional additive selected from a heavy metal mixture oxide spinel, or a copper salt.

In a further aspect, the laser direct structure additive is a copper-containing material. In a still further aspect, the copper-containing material is copper hydroxide phosphate. In a yet further aspect, the laser direct structuring (LDS) additive comprises copper chromium oxide. In a still further aspect, the laser direct structuring (LDS) additive consists essentially of copper chromium oxide. In a still further aspect, the laser direct structuring (LDS) additive consists essentially of copper hydroxide phosphate.

In a further aspect, the LDS is a metal-oxide coated filler is antimony doped tin oxide coating on a mica substrate, a copper-containing metal oxide, a zinc-containing metal oxide, a tin-containing metal oxide, a magnesium-containing metal oxide, an aluminum-containing metal oxide, a gold-containing metal oxide, and a silver-containing metal oxide, or a combination including at least one of the foregoing metal oxides, and the substrate may be any other mineral, such as silica.

The amount of the LDS additive included is sufficient to enable plating of the track formed after activation by the laser while not adversely affecting mechanical properties.

In a further aspect, the laser direct structure additive is present in an amount from about 0.5 wt % to about 70 wt %. In a still further aspect, the laser direct structure additive is present in an amount from about 0.5 wt % to about 60 wt %. In yet a further aspect, the laser direct structure additive is present in an amount from about 0.5 wt % to about 50 wt %. In an even further aspect, the laser direct structure additive is present in an amount from about 0.5 wt % to about 40 wt %. In a still further aspect, the laser direct structure additive is present in an amount from about 0.5 wt % to about 30 wt %. In yet a further aspect, the laser direct structure additive is present in an amount from about 0.5 wt % to about 20 wt %. In an even further aspect, the laser direct structure additive is present in an amount from about 0.5 wt % to about 10 wt %. In a still further aspect, the laser direct structure additive is present in an amount from about 0.5 wt % to about 5 wt %. In yet a further aspect, the laser direct structure additive is present in an amount from about 1 wt % to about 5 wt %. In a yet further aspect, the LDS additive is present in amounts from about 1 to about 15 wt. %. In a still another aspect, the LDS additive is present in amounts from about 2 to about 10 wt. %. In an even further, the LDS additive is present in amounts from about 2 to about 10 wt. %.

As discussed, the LDS additive is selected such that, after activating with a laser, the conductive path can be formed by followed a standard electroless plating process. When the LDS additive is exposed to the laser, elemental metal is released. The laser draws the circuit pattern onto the part and leaves behind a roughened surface containing embedded metal particles. These particles act as nuclei for the crystal growth during a subsequent plating process, such as a copper plating process. Other electroless plating processes that can be used include, but are not limited to, gold plating, nickel plating, silver plating, zinc plating, tin plating or the like.

### Thermally Conductive Filler

In various aspects, the blended thermoplastic compositions of the present disclosure comprise one or more thermally conductive fillers can be used.

In a further aspect, the thermally conductive filler is selected from a high thermally conductive filler and a low thermally conductive filler; wherein the high thermally conductive filler has a thermal conductivity greater than or equal to about 50 W/mK; and, wherein the low thermally conductive filler has a thermal conductivity from about 10 W/mK to about 30 W/mK; or a combinations thereof.

In a further aspect, the thermally conductive filler is a high thermally conductive filler. Examples of high thermally conductive filler include, but are not limited to, AlN (aluminum nitride), Al₄C₃ (aluminum carbide), Al₂O₃ (Aluminum oxide), BN (boron nitride), AlON (aluminum oxynitride), MgSiN₂ (magnesium silicon nitride), SiC (silicon carbide), Si₃N₄ (silicon nitride), graphite, expanded graphite, graphene, and carbon fiber. In a still further aspect, the high thermally conductive filler is selected from AlN, Al₄C₃, Al₂O₃, BN, AlON, MgSiN₂, SiC, Si₃N₄, graphite, expanded graphite, graphene, and carbon fiber, or combinations thereof. In a still further aspect, the high thermally conductive filler is selected from AlN, Al₂O₃, BN, SiC, graphite, expanded graphite, and carbon fiber, or combinations thereof. In yet a further aspect, the high thermally conductive filler is selected from BN, graphite, and expanded graphite, or combinations thereof. In an even further aspect, the high thermally conductive filler is selected from AlN, Al₂O₃, SiC, and carbon fiber, or combinations thereof. In a still further aspect, the high thermally conductive filler is selected from BN, graphite, and expanded graphite, or combinations thereof.

In various aspects, the intrinsic thermal conductivity of the high thermally conductive filler is greater than or equal to 50 W/mK. In a further aspect, the intrinsic thermal conductivity of the high thermally conductive filler is greater than or equal to 100 W/mK. In a still further aspect, the intrinsic thermal conductivity of the high thermally conductive filler is greater than or equal to 150 W/mK.

In a further aspect, the thermally conductive filler is a low thermally conductive filler. Examples of low thermally conductive fillers include, but are not limited to, ZnS (zinc sulfide), CaO (calcium oxide), MgO (magnesium oxide), ZnO (Zinc oxide), and TiO₂ (titanium dioxide). In a still further aspect, the low thermally conductive filler is selected from ZnS, CaO, MgO, ZnO, and TiO₂, or combinations thereof.

In various aspects, the intrinsic thermal conductivity of the low thermally conductive filler is from about 10 W/mK to about 30 W/mK. In a further aspect, the intrinsic thermal conductivity of the low thermally conductive filler is from about 15 W/mK to about 30 W/mK. In a still further aspect, the intrinsic thermal conductivity of the low thermally conductive filler is from about 20 W/mK to about 30 W/mK.

In a further aspect, the thermally conductive filler is present in an amount from about 10 wt % to about 60 wt %. In a still further aspect, the thermally conductive filler is present in an amount from about 10 wt % to about 55 wt %. In yet a further aspect, the thermally conductive filler is present in an amount from about 10 wt % to about 50 wt %. In an even further aspect, the thermally conductive filler is present in an amount from about 10 wt % to about 40 wt %. In a still further aspect, the thermally conductive filler is present in an amount from about 15 wt % to about 60 wt %. In yet a further aspect, the thermally conductive filler is present in an amount from about 20 wt % to about 60 wt %. In an even further aspect, the thermally conductive filler is present in an amount from about 20 wt % to about 50 wt %.

The graphite used in the present disclosure can be synthetically produced or naturally produced, or can be expandable graphite or expanded graphite with a thickness smaller than 1 micron. In one aspect, the graphite is naturally produced. There are three types of naturally produced graphite that are commercially available. They are flake graphite, amorphous graphite and crystal vein graphite. In one aspect, the graphite is flake graphite, wherein the flake graphite is typically found as discrete flakes ranging in size from 10-800 micrometers in diameter and 1-150 micrometers thick and purities ranging from 80-99.9% carbon. In another aspect the graphite is spherical.

The boron nitride used in the disclosure is typically hexagonal boron nitride (h-BN), which can be complete h-BN or turbostratic boron nitride (t-BN). The BN particle can be large sized single BN crystal powder, agglomerate of small sized BN particles, the mixture thereof, the agglomerated spherical powder, or BN fiber. In one aspect, the BN average particle size or D50 in diameter can range from 1 to 500 micrometers. In another aspect, within this range, the boron nitride particles have a size of greater than or equal to about 3, or greater than or equal to about 5 micrometers. The particle size indicated here means the single BN particle or its agglomerate at any of their dimensions. In one aspect, the BN has a BN purity ranging from 95% to 99.8%. In one aspect, a large single crystal sized flake BN with an average size ranging from 3 to 50 micrometer and a BN purity of over 98% is used.

In a further aspect, the thermally conductive filler comprises a sizing or coating material. In a still further aspect, the thermally conductive filler is coated with an amino-silane, polyurethane, vinyl-silane, epoxy-silane, or epoxy. In a yet further aspect, the blended thermoplastic composition comprises a polyamide; and at least one thermally conductive filler coated with an amino silane.

In a further aspect, the blended thermoplastic composition comprises a polyamide, polystyrene, high impact modified polystyrene, polyurethane, polyphenylene oxide-polystyrene blends, polyphenylene ether (PPE), polyoxymethylene (POM), or combinations thereof and at least one thermally conductive filler that is amino-silane coated. In an even further aspect, the blended thermoplastic composition comprises a polyetherimide (PEI), liquid crystal polymers (LPC), polyetheretherketone (PEEK), poly ether sulphone (PES), polyphenylene Sulfide (PPS), or combinations thereof; and at least one thermally conductive filler that is polyurethane coated. In a still further aspect, the blended thermoplastic composition comprises a polypropylene, polyethylene, ethylene based copolymer, acrylonitrile-butadiene-styrene (ABS) terpolymer, acrylic polymer, or combinations thereof; and at least one thermally conductive filler that is vinyl-silane coated. In a yet further aspect, the blended thermoplastic composition comprises a polycarbonate (PC), polybutylene terephthalate (PBT), polyester, polyethylene terephthalate (PET), polycyclohexylendimethylene terephthalate (PCT), or combinations thereof; and at least one thermally conductive filler coated with an epoxy-silane, epoxy, and/or polyurethane.

### Thermally Insulating Filler

In various aspects, the blended thermoplastic compositions of the present disclosure can further comprise one or more thermally insulating fillers can be used. Examples of thermally insulating fillers include, but are not limited to, H₂Mg₃(SiO₃)₄ (Talc), CaCO₃ (calcium carbonate), Mg(OH)₂ (magnesium hydroxide), mica, BaO (barium oxide), γ-AlO(OH) (boehmite), α-AlO(OH) (diaspore), Al(OH)₃ (gibbsite), BaSO₄ (barium sulfate), CaSiO₃ (wollastonite), ZrO₂ (zirconium oxide), SiO₂ (silicon oxide), glass beads, glass fiber, MgO.xAl₂O₃ (magnesium aluminate), CaMg(CO₃)₂ (dolomite), ceramic-coated graphite, and various types of clay, or a combinations thereof.

In a further aspect, the thermally insulating filler is selected from Mg(OH)₂, CaCO₃, mica, γ-AlO(OH), BaO, BaSO₄, AlO(OH), CaSiO₃, ZrO₂, SiO₂, glass beads, glass fiber, H₂Mg₃(SiO₃)₄, AL(OH)₃, MgO.xAl₂O₃, CaMg(CO₃)₂, ceramic-coated graphite, and clay, or combinations thereof. In a still further aspect, the thermally insulating filler is selected from Mg(OH)₂, CaCO₃, mica, γ-AlO(OH), SiO₂, glass beads, glass fiber, H₂Mg₃(SiO₃)₄, Al(OH)₃, and clay, or combinations thereof. In yet a further aspect, the thermally insulating filler is selected from Mg(OH)₂, glass fiber, H₂Mg₃(SiO₃)₄, and Al(OH)₃, or combinations thereof. In an even further aspect, the thermally insulating filler is selected from CaCO₃, γ-AlO(OH), SiO₂, glass beads, and clay. In a still further aspect, the thermally insulating filler is selected from Mg(OH)₂, glass fiber, H₂Mg₃(SiO₃)₄, and Al(OH)₃, or combinations thereof.

In a further aspect, the thermally insulating filler has an intrinsic thermal conductivity less than or equal to about 10 W/mK. In a still further aspect, the intrinsic thermal conductivity of the thermally insulating filler is less than or equal to about 7.5 W/mK. In a yet further aspect, the intrinsic thermal conductivity of the thermally insulating filler is less than or equal to about 5 W/mK.

In a further aspect, the thermally insulating filler comprises a sizing or coating material. In a still further aspect, the thermally insulating filler is coated with an amino-silane, polyurethane, vinyl-silane, epoxy-silane, or epoxy. In a yet further aspect, the blended thermoplastic composition comprises a polyamide; and at least one thermally insulating filler coated with an amino silane.

In a further aspect, the blended thermoplastic composition comprises a polyamide, polystyrene, high impact modified polystyrene, polyurethane, polyphenylene oxide-polystyrene blends, polyphenylene ether (PPE), polyoxymethylene (POM), or combinations thereof; and at least one thermally insulating filler that is amino-silane coated. In an even further aspect, the blended thermoplastic composition comprises a polyetherimide (PEI), liquid crystal polymers (LPC), polyetheretherketone (PEEK), poly ether sulphone (PES), polyphenylene Sulfide (PPS), or combinations thereof; and at least one thermally insulating filler that is polyurethane coated. In a still further aspect, the blended thermoplastic composition comprises a polypropylene, polyethylene, ethylene based copolymer, acrylonitrile-butadiene-styrene (ABS) terpolymer, acrylic polymer, or combinations thereof; and at least one thermally insulating filler that is vinyl-silane coated. In a yet further aspect, the blended thermoplastic composition comprises a polycarbonate (PC), polybutylene terephthalate (PBT), polyester, polyethylene terephthalate (PET), polycyclohexylendimethylene terephthalate (PCT), or combinations thereof; and at least one thermally insulating filler coated with an epoxy-silane, epoxy, and/or polyurethane.

### Optional Filler

The disclosed polymer compositions further comprise an reinforcing filler, such as, for example, an inorganic filler or reinforcing agent. The specific composition of a filler, can vary, provided that the filler is chemically compatible with the remaining components of the polymer composition. In one aspect, the polymer composition comprises a mineral filler. In another aspect, the polymer composition comprises a filler comprising talc. In another aspect, the polymer composition comprises a filler comprising a carbon fiber. In another aspect, the polymer composition comprises a filler comprising a glass fiber.

In a further aspect, the disclosed polymer compositions further comprise a filler selected from amino-silane treated fillers, polyurethane treated fillers, vinyl-silane treated fillers, epoxy-silane treated fillers, and epoxy treated fillers, or a combination thereof.

In another aspect, an exemplary filler can comprise silicates and silica powders, such as aluminum silicate (mullite), synthetic calcium silicate, zirconium silicate, fused silica, crystalline silica graphite, natural silica sand, or the like; boron powders, boron-silicate powders, or the like; oxides, such as aluminum oxide, magnesium oxide, or the like; calcium sulfate (as its anhydride, dihydrate or trihydrate), or the like; glass spheres such as hollow and solid glass spheres, silicate spheres, aluminosilicate, or the like; kaolin, including hard kaolin, soft kaolin, calcined kaolin, kaolin comprising various coatings known in the art to facilitate compatibility with the polymeric matrix resin, or the like; single crystal fibers or “whiskers” such as silicon carbide, alumina, boron carbide, iron, nickel, copper, or the like; fibers (including continuous and chopped fibers), sulfides such as molybdenum sulfide, zinc sulfide or the like; and metal oxides such as particulate or fibrous aluminum, bronze, zinc, copper and nickel or the like; flaked fillers such as glass flakes, flaked silicon carbide, aluminum diboride, aluminum flakes, steel flakes or the like; fibrous fillers, for example short inorganic fibers such as those derived from blends comprising at least one of aluminum silicates, aluminum oxides, magnesium oxides, and calcium sulfate hemihydrate or the like; natural fillers and reinforcements, such as wood flour obtained by pulverizing wood, fibrous products such as cellulose, cotton, or the like; combinations comprising at least one of the foregoing fillers or reinforcing agents.

### Optional Polymer Composition Additives

The disclosed polymer compositions can optionally comprise one or more additives conventionally used in the manufacture of molded thermoplastic parts with the proviso that the optional additives do not adversely affect the desired properties of the resulting composition. Mixtures of optional additives can also be used. Such additives can be mixed at a suitable time during the mixing of the components for forming the composite mixture. For example, the disclosed compositions can comprise one or more lubricants, plasticizers, ultraviolet light absorbing additives, anti-dripping agents, dyes, pigments, stabilizers, anti-static agents, flame-retardants, impact modifiers, colorants, antioxidant, and/or mold release agents. In one aspect, the composition further comprises one or more optional additives selected from an antioxidant, flame retardant, and stabilizer. In a further aspect, the composition further comprises a flame retardant.

Exemplary heat stabilizers include, for example, organophosphites such as triphenylphosphite, tris-(2,6-dimethylphenyl)phosphite, tris-(mixed mono- and di-nonylphenyl)phosphite or the like; phosphonates such as dimethylbenzenephosphonate or the like, phosphates such as trimethyl phosphate, or the like, or combinations including at least one of the foregoing heat stabilizers. Heat stabilizers are generally used in amounts of from 0.01 to 0.5 parts by weight based on 100 parts by weight of the total composition, excluding any filler.

Exemplary antioxidants include, for example, organophosphites such as tris(nonyl phenyl)phosphite, tris(2,4-di-t-butylphenyl)phosphite, bis(2,4-di-t-butylphenyl)pentaerythritoldiphosphite, distearylpentaerythritoldiphosphite or the like; alkylated monophenols or polyphenols; alkylated reaction products of polyphenols with dienes, such as tetrakis[methylene(3,5-di-tert-butyl-4-hydroxyhydrocinnamate)]methane, or the like; butylated reaction products of para-cresol or dicyclopentadiene; alkylated hydroquinones; hydroxylatedthiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate or the like; amides of beta-(3,5-di-tert-butyl-4-hydroxyphenyl)-propionic acid or the like, or combinations including at least one of the foregoing antioxidants. Antioxidants are generally used in amounts of from 0.01 to 0.5 parts by weight, based on 100 parts by weight of the total composition, excluding any filler.

Exemplary light stabilizers include, for example, benzotriazoles such as 2-(2-hydroxy-5-methylphenyl)benzotriazole, 2-(2-hydroxy-5-tert-octylphenyl)-benzotriazole and 2-hydroxy-4-n-octoxy benzophenone or the like or combinations including at least one of the foregoing light stabilizers. Light stabilizers are generally used in amounts of from 0.1 to 1.0 parts by weight, based on 100 parts by weight of the total composition, excluding any filler.

Exemplary plasticizers include, for example, phthalic acid esters such as dioctyl-4,5-epoxy-hexahydrophthalate, tris-(octoxycarbonylethyl) isocyanurate, tristearin, epoxidized soybean oil or the like, or combinations including at least one of the foregoing plasticizers. Plasticizers are generally used in amounts of from 0.5 to 3.0 parts by weight, based on 100 parts by weight of the total composition, excluding any filler.

Exemplary antistatic agents include, for example, glycerol monostearate, sodium stearylsulfonate, sodium dodecylbenzenesulfonate or the like, or combinations of the foregoing antistatic agents. In one aspect, carbon fibers, carbon nanofibers, carbon nanotubes, carbon black, or any combination of the foregoing can be used in a polymeric resin containing chemical antistatic agents to render the composition electrostatically dissipative.

Exemplary mold releasing agents include for example, metal stearate, stearyl stearate, pentaerythritoltetrastearate, beeswax, montan wax, paraffin wax, or the like, or combinations including at least one of the foregoing mold release agents. Mold releasing agents are generally used in amounts of from 0.1 to 1.0 parts by weight, based on 100 parts by weight of the total composition, excluding any filler.

Exemplary UV absorbers include for example, hydroxybenzophenones; hydroxybenzotriazoles; hydroxybenzotriazines; cyanoacrylates; oxanilides; benzoxazinones; 2-(2H-benzotriazol-2-yl)-4-(1,1,3,3-tetramethylbutyl)-phenol (CYASORB™ 5411); 2-hydroxy-4-n-octyloxybenzophenone (CYASORB™ 531); 2-[4,6-bis(2,4-dimethylphenyl)-1,3,5-triazin-2-yl]-5-(octyloxy)-phenol (CYASORB™ 1164); 2,2′-(1,4-phenylene)bis(4H-3,1-benzoxazin-4-one) (CYASORB™ UV-3638); 1,3-bis[(2-cyano-3,3-diphenylacryloyl)oxy]-2,2-bis[[(2-cyano-3,3-diphenylacryloyl)oxy]methyl]propane (UVINUL™ 3030); 2,2′-(1,4-phenylene) bis(4H-3,1-benzoxazin-4-one); 1,3-bis[(2-cyano-3,3-diphenylacryloyl)oxy]-2,2-bis[[(2-cyano-3,3-diphenylacryloyl)oxy]methyl]propane; nano-size inorganic materials such as titanium oxide, cerium oxide, and zinc oxide, all with particle size less than 100 nanometers; or the like, or combinations including at least one of the foregoing UV absorbers. UV absorbers are generally used in amounts of from 0.01 to 3.0 parts by weight, based on 100 parts by weight of the total composition, excluding any filler.

Exemplary lubricants include for example, fatty acid esters such as alkyl stearyl esters, e.g., methyl stearate or the like; mixtures of methyl stearate and hydrophilic and hydrophobic surfactants including polyethylene glycol polymers, polypropylene glycol polymers, and copolymers thereof e.g., methyl stearate and polyethylene-polypropylene glycol copolymers in a suitable solvent; or combinations including at least one of the foregoing lubricants. Lubricants are generally used in amounts of from 0.1 to 5 parts by weight, based on 100 parts by weight of the total composition, excluding any filler.

Exemplary blowing agents include for example, low boiling halohydrocarbons and those that generate carbon dioxide; blowing agents that are solid at room temperature and when heated to temperatures higher than their decomposition temperature, generate gases such as nitrogen, carbon dioxide, ammonia gas, such as azodicarbonamide, metal salts of azodicarbonamide, 4,4′ oxybis(benzenesulfonylhydrazide), sodium bicarbonate, ammonium carbonate, or the like, or combinations including at least one of the foregoing blowing agents. Blowing agents are generally used in amounts of from 1 to 20 parts by weight, based on 100 parts by weight of the total composition, excluding any filler.

As noted above, the disclosed polymer compositions can optionally further comprises a flame retardant additive. In various aspects, the flame retardant additive can comprise any flame retardant material or mixture of flame retardant materials suitable for use in the inventive polymer compositions. I

In a further aspect, the flame retardant additive comprises a phosphate containing material. In a yet further aspect, the flame retardant additive comprises a phosphate containing material selected from a phosphine, a phosphine oxide, a bisphosphine, a phosphonium salt, a phosphinic acid salt, a phosphoric ester, and a phosphorous ester, or a combination thereof.

In a further aspect, the flame retardant additive comprises a halogen containing material. In other aspects, the flame retardant additive is free of or substantially free of one or more of phosphate and/or a halogen.

In a further aspect, the flame retardant additive comprises an oligomer organophosphorous flame retardant, including for example, bisphenol A diphenyl phosphate (BPADP). In a yet further aspect, the flame retardant is selected from aromatic polyphosphate oligomers, phenoxyphosphazene oligomers, melamine polyphosphate oligomers, and metal phosphinate oligomers, or a combination thereof. In a still further aspect, the flame retardant is selected from oligomeric phosphate, polymeric phosphate, oligomeric phosphonate, or mixed phosphate/phosphonate ester flame retardant compositions. In an even further aspect, the flame retardant is selected from bisphenol-A bis(diphenyl phosphate), 1,3-phenylene tetraphenyl ester, bisphenol-A bis(diphenyl phosphate), red phosphorous, and Clariant Exolite OP series FR, or a combination thereof. In a still further aspect, the flame retardant is selected from triphenyl phosphate; cresyldiphenylphosphate; tri(isopropylphenyl)phosphate; resorcinol bis(diphenylphosphate); and bisphenol-A bis(diphenyl phosphate). In a yet further aspect, the flame retardant is bisphenol-A bis(diphenyl phosphate).

Additionally, materials to improve flow and other properties can be added to the composition, such as low molecular weight hydrocarbon resins. Particularly useful classes of low molecular weight hydrocarbon resins are those derived from petroleum C₅ to C₉ feedstock that are derived from unsaturated C₅ to C₉ monomers obtained from petroleum cracking. Non-limiting examples include olefins, e.g., pentenes, hexenes, heptenes and the like; diolefins, e.g., pentadienes, hexadienes and the like; cyclic olefins and diolefins, e.g., cyclopentene, cyclopentadiene, cyclohexene, cyclohexadiene, methyl cyclopentadiene and the like; cyclic diolefindienes, e.g., dicyclopentadiene, methylcyclopentadiene dimer and the like; and aromatic hydrocarbons, e.g., vinyltoluenes, indenes, methylindenes and the like. The resins can additionally be partially or fully hydrogenated.

### Methods of Manufacture

The compositions of the present disclosure can be blended with the aforementioned ingredients by a variety of methods involving intimate admixing of the materials with any additional additives desired in the formulation. Because of the availability of melt blending equipment in commercial polymer processing facilities, melt processing methods are generally preferred. Illustrative examples of equipment used in such melt processing methods include: co-rotating and counter-rotating extruders, single screw extruders, co-kneaders, disc-pack processors and various other types of extrusion equipment. The temperature of the melt in the present process is preferably minimized in order to avoid excessive degradation of the resins. It is often desirable to maintain the melt temperature between about 230° C. and about 350° C. in the molten resin composition, although higher temperatures can be used provided that the residence time of the resin in the processing equipment is kept short. In some embodiments the melt processed composition exits processing equipment such as an extruder through small exit holes in a die. The resulting strands of molten resin are cooled by passing the strands through a water bath. The cooled strands can be chopped into small pellets for packaging and further handling.

Compositions can be manufactured by various methods. For example, polymer, and/or other optional components are first blended, optionally with fillers in a HENSCHEL-Mixer®high speed mixer. Other low shear processes, including but not limited to hand mixing, can also accomplish this blending. The blend is then fed into the throat of a twin-screw extruder via a hopper. Alternatively, at least one of the components can be incorporated into the composition by feeding directly into the extruder at the throat and/or downstream through a sidestuffer. Additives can also be compounded into a masterbatch with a desired polymeric resin and fed into the extruder. The extruder is generally operated at a temperature higher than that necessary to cause the composition to flow. The extrudate is immediately quenched in a water batch and pelletized. The pellets, so prepared, when cutting the extrudate can be one-fourth inch long or less as desired. Such pellets can be used for subsequent molding, shaping, or forming.

In one aspect, the laser direct structuring process involves three steps: 1) injection molding, 2) laser structuring, and 3) metallizing.

In a further aspect, during the injection molding step, the laser direct structuring additive and reinforcing filler can be mixed with the thermoplastic polymer. In another aspect, the blend composition further comprises one or more optional additives selected from an antioxidant, flame retardant, inorganic filler, and stabilizer. In a still further aspect, single shot injection molding can be used to produce the parts or articles to be laser structured. In at least one aspect, the polymer composition can be mixed at this step and used in the LDS process. In another aspect, additional ingredients can be added to the polymer composition after this step.

In a further aspect, during the laser structuring step, a laser is used to form a conductive path during the laser structuring step. In a still further aspect, the laser used to form a conductive path is laser direct structuring. In a yet further aspect, laser direct structuring comprises laser etching. In an even further aspect, laser etching is carried out to provide an activated surface.

In a further aspect, at least one laser beam draws at least one pattern on the surface of the polymer composition during the laser structuring step. In a still further aspect, the employed filler composition can release at least one metallic nucleus. In a yet further aspect, the at least one metallic nucleus that has been released can act as a catalyst for reductive copper plating process.

Laser direct structuring is can be carried out on an article comprising the disclosed blended thermoplastic compositions at a power setting from about 1 W to about 14 W, a frequency from about 30 kHz to about 120 kHz, and a speed of about 1 m/s to about 5 m/s. In a further aspect, laser etching is carried out at about 1 w to about 10 w power with a frequency from about 30 kHz to about 110 kHz and a speed of about 1 m/s to about 5 m/s. In a still further aspect, laser etching is carried out at about 1 w to about 10 w power with a frequency from about 40 kHz to about 100 kHz and a speed of about 2 m/s to about 4 m/s. In a yet further aspect, laser etching is carried out at about 3.5 w power with a frequency of about 40 kHz and a speed of about 2 m/s.

In various aspects, laser direct structuring is carried out on an article comprising the disclosed blended thermoplastic compositions at a power setting of about 2 W. In a further aspect, laser direct structuring is carried out on an article comprising the disclosed blended thermoplastic compositions at a power setting of about 3 W. In a still further aspect, laser direct structuring is carried out on an article comprising the disclosed blended thermoplastic compositions at a power setting of about 4 W. In a yet further aspect, laser direct structuring is carried out on an article comprising the disclosed blended thermoplastic compositions at a power setting of about 5 W. In an even further aspect, laser direct structuring is carried out on an article comprising the disclosed blended thermoplastic compositions at a power setting of about 6 W. In a still further aspect, laser direct structuring is carried out on an article comprising the disclosed blended thermoplastic compositions at a power setting of about 7 W. In a yet further aspect, laser direct structuring is carried out on an article comprising the disclosed blended thermoplastic compositions at a power setting of about 8 W. In an even further aspect, laser direct structuring is carried out on an article comprising the disclosed blended thermoplastic compositions at a power setting of about 9 W. In a still further aspect, laser direct structuring is carried out on an article comprising the disclosed blended thermoplastic compositions at a power setting of about 10 W. In a yet further aspect, laser direct structuring is carried out on an article comprising the disclosed blended thermoplastic compositions at a power setting of about 11 W.

In various aspects, laser direct structuring is carried out on an article comprising the disclosed blended thermoplastic compositions at a frequency setting of about 40 kHz. In a further aspect, laser direct structuring is carried out on an article comprising the disclosed blended thermoplastic compositions at a frequency setting of about 50 kHz. In a still further aspect, laser direct structuring is carried out on an article comprising the disclosed blended thermoplastic compositions at a frequency setting of about 60 kHz. In a yet further aspect, laser direct structuring is carried out on an article comprising the disclosed blended thermoplastic compositions at a frequency setting of about 70 kHz. In an even further aspect, laser direct structuring is carried out on an article comprising the disclosed blended thermoplastic compositions at a frequency setting of about 80 kHz. In a still further aspect, laser direct structuring is carried out on an article comprising the disclosed blended thermoplastic compositions at a frequency setting of about 90 kHz. In a yet further aspect, laser direct structuring is carried out on an article comprising the disclosed blended thermoplastic compositions at a frequency setting of about 100 kHz. In an even further aspect, laser direct structuring is carried out on an article comprising the disclosed blended thermoplastic compositions at a frequency setting of about 110 kHz. In a still further aspect, laser direct structuring is carried out on an article comprising the disclosed blended thermoplastic compositions at a frequency setting of about 120 kHz.

In various aspects, laser direct structuring is carried out on an article comprising the disclosed blended thermoplastic compositions at a speed of about 1 m/s. In a further aspect, laser direct structuring is carried out on an article comprising the disclosed blended thermoplastic compositions at a speed of about 2 m/s. In a still further aspect, laser direct structuring is carried out on an article comprising the disclosed blended thermoplastic compositions at a speed of about 3 m/s. In a yet further aspect, laser direct structuring is carried out on an article comprising the disclosed blended thermoplastic compositions at a speed of about 4 m/s. In an even further aspect, laser direct structuring is carried out on an article comprising the disclosed blended thermoplastic compositions at a speed of about 5 m/s.

In a further aspect, a rough surface can form in the LDS process. In a still further aspect, the rough surface can entangle the copper plate with the polymer matrix in the polymer composition, which can provide adhesion between the copper plate and the polymer composition. The metalizing step can, in various aspects, be performed using conventional techniques. For example, in one aspect, an electroless copper plating bath is used during the metallization step in the LDS process. Thus, in various aspects, plating a metal layer onto a conductive path is metallization. In a still further aspect, metallization can comprise the steps: a) cleaning the etched surface; b) additive build-up of tracks; and c) plating.

In various aspects, the present disclosure pertains to methods of improving thermal conductivity properties of a blended thermoplastic composition, the method comprising the step of combining: (a) from about 30 wt % to about 90 wt % of a polyamide polymer; (b) from about 10 wt % to about 70 wt % of a thermally conductive filler; and (c) from about 0.05 wt % to about 20 wt % of a laser direct structuring additive; wherein the combined weight percent value of all components does not exceed about 100 wt %; wherein all weight percent values are based on the total weight of the composition; wherein a molded sample of the blended thermoplastic composition has a through plane thermal conductivity of at least about 0.40 W/mK when determined in accordance with ASTM E1461; and wherein a molded sample of the blended thermoplastic composition exhibits a plating index value of at least about 0.5.

In various aspects, the present disclosure pertains to methods of improving thermal conductivity properties of a blended thermoplastic composition, the method comprising the step of combining: a) from about 30 wt % to about 90 wt % of a polymer component; b) from about 10 wt % to about 70 wt % of a thermally conductive filler; and c) from about 0.05 wt % to about 20 wt % of a laser direct structuring additive; wherein the combined weight percent value of all components does not exceed about 100 wt %; wherein all weight percent values are based on the total weight of the composition; wherein a molded sample of the blended thermoplastic composition has a through plane thermal conductivity of at least about 0.40 W/mK when determined in accordance with ASTM E1461; and wherein a molded sample of the blended thermoplastic composition exhibits a plating index value of at least about 0.5.

In a further aspect, the polymer component of the method comprises a polypropylene, a polyethylene, an ethylene-based copolymer, a polycarbonate, a polyamide, a polyester, a polyoxymethylene, a liquid crystal polymer, a polyphenylene sulfide, a polyphenylene ether, a polystyrene, a acrylonitrile-butadiene-styrene terpolymer, an acrylic polymer, a polyetherimide, a polyurethane, a polyethersulphone, or a polyetheretherketone, or combinations thereof. In a still further aspect, the polyester is a terephthalate polyester. In a yet further aspect, the terephthalate polyester comprises a polybutylene terephthalate, a polyethylene terephthalate, or a polycyclohexylenedimethylene terephthalate, or combinations thereof. In an even further aspect, the polyester comprises a blend of at least one polyphenylene oxide and at least one polystyrene.

In a further aspect, the polymer component of the method comprises a polyamide polymer. In a still further aspect, the polyamide polymer present in an amount from about 30 wt % to about 90 wt % of a polyamide polymer.

### Articles of Manufacture

Shaped, formed, or molded articles including the polymer compositions are also provided. The polymer compositions can be molded into useful shaped articles by a variety of means such as injection molding, extrusion, rotational molding, blow molding and thermoforming to form articles such as, for example, personal computers, notebook and portable computers, cell phone antennas and other such communications equipment, medical applications, RFID applications, automotive applications, and the like.

The blended polymer compositions, disclosed herein provide robust plating performance while maintaining good mechanical properties. Evaluation of the mechanical properties can be performed through various tests, such as Izod impact test (notched and/or unnotched), Charpy test, Gardner test, etc., according to several standards (e.g., ASTM D256). Robustness of plating performance can be measured via a performance ranking, or plating ranking, ranging from top performance (e.g., “best”) to bottom performance. The ranking can be partitioned in various levels. In one aspect, a plating ranking can have a level of “10” for top performance and a level of “0” for bottom performance.

In a further aspect, the method comprises forming a molded part from the composition. In another aspect, the method further comprises subjecting the molded part to a laser direct structuring process.

In one aspect, the article comprises the product of extrusion molding or injection molding a composition comprising a thermoplastic polymer, a laser directing structuring additive and a reinforcing filler.

In a further aspect, the molded article further comprises a conductive path formed by activation with a laser. In a yet further aspect, the article further comprises a metal layer plated onto the conductive path. In an even further aspect, the metal layer is a copper layer. In a still further aspect, the metal layer has a thickness of about 0.8 micrometers or higher as measured according to ASTM B568.

In various aspects, the polymer composition can be used in the field of electronics. In a further aspect, non-limiting examples of fields which can use the disclosed blended polymer compositions include electrical, electro-mechanical, Radio Frequency (RF) technology, telecommunication, automotive, aviation, medical, sensor, military, and security. In a still further aspect, the use of the disclosed blended polymer compositions can also be present in overlapping fields, for example in mechatronic systems that integrate mechanical and electrical properties which may, for example, be used in automotive or medical engineering.

In one aspect, molded articles according to the present disclosure can be used to produce a device in one or more of the foregoing fields. In a still further aspect, non-limiting examples of such devices in these fields which can use the disclosed blended polymer compositions according to the present disclosure include computer devices, household appliances, decoration devices, electromagnetic interference devices, printed circuits, Wi-Fi devices, Bluetooth devices, GPS devices, cellular antenna devices, smart phone devices, automotive devices, military devices, aerospace devices, medical devices, such as hearing aids, sensor devices, security devices, shielding devices, RF antenna devices, LED devices, or RFID devices. In yet a further aspect, the device is selected from a computer device, electromagnetic interference device, automotive device, medical device, sensor device, security device, shielding device, RF antenna device, LED device and RFID device. In an even further aspect, the device is selected from a computer device, sensor device, security device, RF antenna device, LED device and RFID device. In a still further aspect, the device is selected from a computer device, LED device and RFID device. In yet a further aspect, the device is a LED device. In an even further aspect, the device is a LED lamp.

In a still further aspect, the molded articles can be used to manufacture devices in the automotive field. In a further aspect, non-limiting examples of such devices in the automotive field which can use the disclosed blended polymer compositions in the vehicle's interior include adaptive cruise control, headlight sensors, windshield wiper sensors, and door/window switches. In a further aspect, non-limiting examples of devices in the automotive field which can use the disclosed blended polymer compositions in the vehicle's exterior include pressure and flow sensors for engine management, air conditioning, crash detection, and exterior lighting fixtures.

In a further aspect, the resulting disclosed compositions can be used to provide any desired shaped, formed, or molded articles. For example, the disclosed compositions can be molded into useful shaped articles by a variety of means such as injection molding, extrusion, rotational molding, blow molding and thermoforming. As noted above, the disclosed compositions are particularly well suited for use in the manufacture of electronic components and devices. As such, according to some aspects, the disclosed compositions can be used to form articles such as printed circuit board carriers, burn in test sockets, flex brackets for hard disk drives, and the like.

In various aspects, a molded article comprising the disclosed blended thermoplastic compositions can have a melt volume rate (“MVR”) from about 10 cm³/10 min to about 300 cm³/10 min when determined in accordance with ASTM D1238 under a load of 5.0 kg and at a temperature of 275° C. In a further aspect, a molded article comprising the disclosed blended thermoplastic compositions can have a melt volume rate (“MVR”) from about 30 cm³/10 min to about 250 cm³/10 min when determined in accordance with ASTM D1238 under a load of 5.0 kg and at a temperature of 275° C. In a still further aspect, a molded article comprising the disclosed blended thermoplastic compositions can have a melt volume rate (“MVR”) from about 50 cm³/10 min to about 200 cm³/10 min when determined in accordance with ASTM D1238 under a load of 5.0 kg and at a temperature of 275° C.

In various aspects, a molded article comprising the disclosed blended thermoplastic compositions can have a modulus of elasticity from about 2,000 MPa to about 18,000 MPa when determined in accordance with ASTM D638 at a speed of 5 mm/min. In a further aspect, a molded article comprising the disclosed blended thermoplastic compositions can have a modulus of elasticity from about 3,000 MPa to about 16,000 MPa when determined in accordance with ASTM D638 at a speed of 5 mm/min. In a still further aspect, a molded article comprising the disclosed blended thermoplastic compositions can have a modulus of elasticity from about 5,000 MPa to about 15,000 MPa when determined in accordance with ASTM D638 at a speed of 5 mm/min.

In various aspects, a molded article comprising the disclosed blended thermoplastic compositions can have a tensile stress at break from about 20 MPa to about 200 MPa when determined in accordance with ASTM D638 at a speed of 5 mm/min. In a further aspect, a molded article comprising the disclosed blended thermoplastic compositions can have a tensile stress at break from about 40 MPa to about 150 MPa when determined in accordance with ASTM D638 at a speed of 5 mm/min. In a still further aspect, a molded article comprising the disclosed blended thermoplastic compositions can have a tensile stress at break from about 50 MPa to about 100 MPa when determined in accordance with ASTM D638 at a speed of 5 mm/min.

In various aspects, a molded article comprising the disclosed blended thermoplastic compositions can have a tensile elongation at break from about 0.5% to about 5% when determined in accordance with ASTM D638 at a speed of 5 mm/min. In a further aspect, a molded article comprising the disclosed blended thermoplastic compositions can have a tensile elongation at break from about 0.5% to about 3% when determined in accordance with ASTM D638 at a speed of 5 mm/min. In a still further aspect, a molded article comprising the disclosed blended thermoplastic compositions can have a tensile elongation at break from about 0.5% to about 1.5% when determined in accordance with ASTM D638 at a speed of 5 mm/min.

In various aspects, a molded article comprising the disclosed blended thermoplastic compositions can have a flexural modulus from about 2,000 MPa to about 20,000 MPa when determined in accordance with ASTM D790 at a speed of 1.27 mm/min. In a further aspect, a molded article comprising the disclosed blended thermoplastic compositions can have a flexural modulus from about 4,000 MPa to about 18,000 MPa when determined in accordance with ASTM D790 at a speed of 1.27 mm/min. In a still further aspect, a molded article comprising the disclosed blended thermoplastic compositions can have a flexural modulus from about 5,000 MPa to about 16,000 MPa when determined in accordance with ASTM D790 at a speed of 1.27 mm/min.

In various aspects, a molded article comprising the disclosed blended thermoplastic compositions can have a flexural stress at 5% strain from about 0 MPa to about 200 MPa when determined in accordance with ASTM D790 at a speed of 1.27 mm/min. In a further aspect, a molded article comprising the disclosed blended thermoplastic compositions can have a flexural stress at 5% from about 0 MPa to about 150 MPa when determined in accordance with ASTM D790 at a speed of 1.27 mm/min. In a still further aspect, a molded article comprising the disclosed blended thermoplastic compositions can have a flexural stress at 5% from about 0 MPa to about 100 MPa when determined in accordance with ASTM D790 at a speed of 1.27 mm/min.

In various aspects, a molded article comprising the disclosed blended thermoplastic compositions can have a flexural stress at yield from about 20 MPa to about 200 MPa when determined in accordance with ASTM D790 at a speed of 1.27 mm/min. In a further aspect, a molded article comprising the disclosed blended thermoplastic compositions can have a flexural stress at yield from about 50 MPa to about 180 MPa when determined in accordance with ASTM D790 at a speed of 1.27 mm/min. In a still further aspect, a molded article comprising the disclosed blended thermoplastic compositions can have a flexural stress at yield from about 80 MPa to about 140 MPa when determined in accordance with ASTM D790 at a speed of 1.27 mm/min.

In various aspects, a molded article comprising the disclosed blended thermoplastic compositions can have a flexural stress at break from about 20 MPa to about 200 MPa when determined in accordance with ASTM D790 at a speed of 1.27 mm/min. In a further aspect, a molded article comprising the disclosed blended thermoplastic compositions can have a flexural stress at break from about 50 MPa to about 180 MPa when determined in accordance with ASTM D790 at a speed of 1.27 mm/min. In a still further aspect, a molded article comprising the disclosed blended thermoplastic compositions can have a flexural stress at break from about 80 MPa to about 140 MPa when determined in accordance with ASTM D790 at a speed of 1.27 mm/min.

In various aspects, a molded article comprising the disclosed blended thermoplastic compositions can have a notched Izod impact strength from about 10 J/m to about 50 J/m when determined in accordance with ASTM D256. In a further aspect, a molded article comprising the disclosed blended thermoplastic compositions can have a notched Izod impact strength from about 15 J/m to about 45 J/m when determined in accordance with ASTM D256. In a still further aspect, a molded article comprising the disclosed blended thermoplastic compositions can have a notched Izod impact strength from about 20 J/m to about 40 J/m when determined in accordance with ASTM D256.

In various aspects, a molded article comprising the disclosed blended thermoplastic compositions can have an unnotched Izod impact strength from about 100 J/m to about 800 J/m when determined in accordance with ASTM D256. In a further aspect, a molded article comprising the disclosed blended thermoplastic compositions can have an unnotched Izod impact strength from about 200 J/m to about 700 J/m when determined in accordance with ASTM D256. In a still further aspect, a molded article comprising the disclosed blended thermoplastic compositions can have an unnotched Izod impact strength from about 300 J/m to about 600 J/m when determined in accordance with ASTM D256.

In various aspects, a molded article comprising the disclosed blended thermoplastic compositions can have a heat deflection temperature from about 100° C. to about 280° C. when determined in accordance with ASTM D648. In a further aspect, a molded article comprising the disclosed blended thermoplastic compositions can have a heat deflection temperature from about 125° C. to about 270° C. when determined in accordance with ASTM D648. In a still further aspect, a molded article comprising the disclosed blended thermoplastic compositions can have a heat deflection temperature from about 150° C. to about 260° C. when determined in accordance with ASTM D648.

In various aspects, the present disclosure pertains to and includes at least the following aspects.

Aspect 1. A blended thermoplastic composition comprising: a) from about 30 wt % to about 90 wt % of at least one polymer component; b) from about 9 wt % to about 69.95 wt % of a thermally conductive filler; and c) from about 0.05 wt % to about 20 wt % of a laser direct structuring additive; wherein the combined weight percent value of all components does not exceed about 100 wt %; wherein all weight percent values are based on the total weight of the composition; wherein a molded sample of the blended thermoplastic composition has a through plane thermal conductivity of at least about 0.40 W/mK when determined in accordance with ASTM E1461; and wherein a molded sample of the blended thermoplastic composition exhibits a plating index value of at least about 0.5.

Aspect 2. The composition of Aspect 1, wherein the polymer component is selected from a polypropylene, a polyethylene, an ethylene-based copolymer, a polycarbonate, a polyamide, a polyester, a polyoxymethylene (POM), a liquid crystal polymer (LPC), a polyphenylene sulfide (PPS), a polyphenylene ether (PPE), a polystyrene, a acrylonitrile-butadiene-styrene terpolymer, an acrylic polymer, a polyetherimide, a polyurethane, a polyethersulphone (PES), polyetheretherketone (PEEK), or combinations thereof.

Aspect 3. The composition of Aspect 2, wherein the polyester is a terephthalate polyester.

Aspect 4. The composition of Aspect 3, wherein the terephthalate polyester comprises a polybutylene terephthalate, a polyethylene terephthalate, or a polycyclohexylenedimethylene terephthalate, or combinations thereof.

Aspect 5. The composition of Aspect 2, wherein the polyester comprises a blend of at least one polyphenylene oxide and at least one polystyrene.

Aspect 6. The composition of Aspects 1 or 2, wherein the polymer component is a polyamide polymer.

Aspect 7. The composition of Aspect 6, wherein the polyamide polymer present in an amount from about 30 wt % to about 90 wt % of a polyamide polymer.

Aspect 8. The composition of Aspects 6 or 7, wherein the polyamide polymer comprises a blend of two or polyamide polymers.

Aspect 9. The composition of Aspects 6-8, wherein the polyamide polymer comprises polyamide-4; polyamide-4,6; polyamide-4,9; polyamide-6; polyamide-6,6; polyamide 6,9; polyamide-6,10; polyamide-6,12; polyamide 10; polyamide 10,10; polyamide 10,12; polyamide 11; polyamide-12; polyamide 12,12; amorphous polyamide resins; polyamide PPA; polyamide 4T; polyamide 6T; polyamide 6/6T; or polyamide 6,6/6T; polyamide 9T; or combinations thereof.

Aspect 10. The composition of Aspect 9, wherein the polyamide polymer comprises polyamide 4,6; polyamide 6; polyamide 6,6; polyamide 6,12; polyamide 10, or polyamide 10,10; or combinations thereof.

Aspect 11. The composition of Aspect 10, wherein the polyamide polymer comprises polyamide 9T, polyamide 6; polyamide 6,6; or polyamide 10,10; or combinations thereof.

Aspect 12. The composition of Aspect 10, wherein the polyamide polymer is polyamide 6,6 or polyamide 10,10, or combinations thereof.

Aspect 13. The composition of Aspects 6-8, wherein the polyamide polymer comprises a first polyamide polymer and a second polyamide polymer.

Aspect 14. The composition of Aspect 13, wherein the first polyamide polymer comprises polyamide 6 and polyamide 6,6; and wherein the second polyamide polymer is selected from polyamide 10,10; polyamide 10,12; or polyamide 12,12; or combinations thereof.

Aspect 15. The composition of any of Aspects 6-14, wherein the polyamide polymer has a low viscosity.

Aspect 16. The composition of any of Aspects 6-15, wherein the polyamide polymer is present in an amount from about 30 wt % to about 70 wt %.

Aspect 17. The composition of any of Aspects 6-15, wherein the polyamide polymer is present in an amount from about 30 wt % to about 65 wt %.

Aspect 18. The composition of any of Aspects 6-15, wherein the polyamide polymer is present in an amount from about 30 wt % to about 60 wt %.

Aspect 19. The composition of any of Aspects 1-18, wherein the thermally conductive filler is a high thermally conductive filler, wherein the high thermally conductive filler has a thermal conductivity greater than or equal to about 50 W/mK; or a low thermally conductive filler, wherein the low thermally conductive filler has a thermal conductivity from about 10 W/mK to about 30 W/mK; or a combinations thereof.

Aspect 20. The composition of any of Aspects 1-19, wherein the high thermally conductive filler comprises AlN, Al₄C₃, Al₂O₃, BN, AlON, MgSiN₂, SiC, Si₃N₄, graphite, expanded graphite, graphene, or carbon fiber, or combinations thereof.

Aspect 21. The composition of any of Aspects 1-19, wherein the high thermally conductive filler comprises AlN, Al₂O₃, BN, SiC, graphite, expanded graphite, or carbon fiber, or combinations thereof.

Aspect 22. The composition of any of Aspects 1-19, wherein the high thermally conductive filler comprises BN, graphite, or expanded graphite, or combinations thereof.

Aspect 23. The composition of any of Aspects 1-19, wherein the low thermally conductive filler comprises ZnS, CaO, MgO, ZnO, or TiO₂, or combinations thereof.

Aspect 24. The composition of any of Aspects 1-23, wherein the thermally conductive filler is present in an amount from about 10 wt % to about 60 wt %.

Aspect 25. The composition of any of Aspects 1-23, wherein the thermally conductive filler is present in an amount from about 10 wt % to about 55 wt %.

Aspect 26. The composition of any of Aspects 1-23, wherein the thermally conductive filler is present in an amount from about 10 wt % to about 50 wt %.

Aspect 27. The composition of any of Aspects 1-23, wherein the thermally conductive filler is present in an amount from about 10 wt % to about 40 wt %.

Aspect 28. The composition of any of Aspects 1-23, wherein the thermally conductive filler is present in an amount from about 15 wt % to about 60 wt %.

Aspect 29. The composition of any of Aspects 1-23, wherein the thermally conductive filler is present in an amount from about 20 wt % to about 60 wt %.

Aspect 30. The composition of any of Aspects 1-23, wherein the thermally conductive filler is present in an amount from about 20 wt % to about 50 wt %.

Aspect 31. The composition of any of Aspects 1-30, further comprising a thermally insulating filler.

Aspect 32. The composition of Aspect 18, wherein the thermally insulating filler has a conductivity of less than or equal to about 10 W/mK.

Aspect 33. The composition of Aspect 31 or 32, wherein the thermally insulating filler comprises Mg(OH)₂, CaCO₃, mica, γ-AlO(OH), BaO, BaSO₄, AlO(OH), CaSiO₃, ZrO₂, SiO₂, glass beads, glass fiber, H₂Mg₃(SiO₃)₄, AL(OH)₃, MgO.xAl₂O₃, CaMg(CO₃)₂, ceramic-coated graphite, or clay, or combinations thereof.

Aspect 34. The composition of Aspect 31 or 32, wherein the thermally insulating filler comprises Mg(OH)₂, CaCO₃, mica, γ-AlO(OH), SiO₂, glass beads, glass fiber, H₂Mg₃(SiO₃)₄, Al(OH)₃, or clay, or combinations thereof.

Aspect 35. The composition of Aspect 31 or 32, wherein the thermally insulating filler comprises Mg(OH)₂, glass fiber, H₂Mg₃(SiO₃)₄, or Al(OH)₃, or combinations thereof.

Aspect 36. The composition of any of Aspects 1-35, wherein the laser direct structure additive is selected from a metal oxide or a metal oxide-coated filler, or a combination thereof.

Aspect 37. The composition of Aspect 36, wherein the laser direct structure additive is a metal oxide comprising a copper-containing metal oxide, a titanium-containing metal oxide, a tin-containing metal oxide, a zinc-containing metal oxide, a magnesium-containing metal oxide, an aluminum-containing metal oxide, a gold-containing metal oxide, or a silver-containing metal oxide, or a combination thereof.

Aspect 38. The composition of Aspect 36, wherein the laser direct structure additive is a metal-oxide coated filler comprising a mineral substrate and a coating comprising an antimony doped tin oxide, a copper-containing metal oxide, a zinc-containing metal oxide, a tin-containing metal oxide, a magnesium-containing metal oxide, an aluminum-containing metal oxide, a gold-containing metal oxide, or a silver-containing metal oxide, or a combination thereof.

Aspect 39. The composition of Aspect 36, wherein the laser direct structure additive is a copper-containing material.

Aspect 40. The composition of any of Aspects 1-38, wherein the laser direct structure additive is copper hydroxide phosphate.

Aspect 41. The composition of any of Aspects 1-40, wherein the laser direct structure additive is present in an amount from about 0.5 wt % to about 70 wt %.

Aspect 42. The composition of any of Aspects 1-40, wherein the laser direct structure additive is present in an amount from about 0.5 wt % to about 60 wt %.

Aspect 43. The composition of any of Aspects 1-40, wherein the laser direct structure additive is present in an amount from about 0.5 wt % to about 50 wt %.

Aspect 44. The composition of any of Aspects 1-40, wherein the laser direct structure additive is present in an amount from about 0.5 wt % to about 40 wt %.

Aspect 45. The composition of any of Aspects 1-40, wherein the laser direct structure additive is present in an amount from about 0.5 wt % to about 30 wt %.

Aspect 46. The composition of any of Aspects 1-40, wherein the laser direct structure additive is present in an amount from about 0.5 wt % to about 20 wt %.

Aspect 47. The composition of any of Aspects 1-40, wherein the laser direct structure additive is present in an amount from about 0.5 wt % to about 10 wt %.

Aspect 48. The composition of any of Aspects 1-40, wherein the laser direct structure additive is present in an amount from about 0.5 wt % to about 5 wt %.

Aspect 49. The composition of any of Aspects 1-40, wherein the laser direct structure additive is present in an amount from about 1 wt % to about 5 wt %.

Aspect 50. The composition of any of Aspects 1-49, wherein a flame retardant is not present.

Aspect 51. The composition of any of Aspects 1-49, further comprising a flame retardant.

Aspect 52. The composition of Aspect 51, wherein the flame retardant is a phosphorous-containing flame retardant.

Aspect 53. The composition of Aspect 52, wherein the phosphorous-containing flame retardant comprises a phosphine, a phosphine oxide, a bisphosphine, a phosphonium salt, a phosphinic acid salt, a phosphoric ester, or a phosphorous ester, or a combination thereof.

Aspect 54. The composition of Aspects 52 and 53, wherein the phosphorous-containing flame retardant is oligomeric.

Aspect 55. The composition of Aspects 52-54, wherein the phosphorous-containing flame retardant comprises an aromatic polyphosphate oligomer, a phenoxyphosphazene oligomer, a melamine polyphosphate oligomer, or a metal phosphinate oligomer, or a combination thereof.

Aspect 56. The composition of Aspects 52-55, wherein the phosphorous-containing flame retardant comprises bisphenol-A bis(diphenyl phosphate), 1,3-phenylene tetraphenyl ester, bisphenol-A bis(diphenyl phosphate), red phosphorous, or Clariant Exolite OP series FR, or a combination thereof.

Aspect 57. The composition of any of Aspects 1-56 further comprising an additive comprising an antioxidant, a lubricant, a thermal stabilizer, an ultraviolet light absorbing additive, a plasticizer, an anti-dripping agent, a mold release agent, an antistatic agent, a dye, a pigment, or a radiation stabilizer, or a combination thereof.

Aspect 58. The composition of any of Aspects 1-57, wherein a molded sample of the blended thermoplastic composition has a through plane thermal conductivity of at least about 0.45 W/mK when determined in accordance with ASTM E1461.

Aspect 59. The composition of any of Aspects 1-57, wherein a molded sample of the blended thermoplastic composition has a through plane thermal conductivity of at least about 0.50 W/mK when determined in accordance with ASTM E1461.

Aspect 60. The composition of any of Aspects 1-57, wherein a molded sample of the blended thermoplastic composition has a through plane thermal conductivity from about 0.40 W/mK to about 25 W/mK when determined in accordance with ASTM E1461.

Aspect 61. The composition of any of Aspects 1-57, wherein a molded sample of the blended thermoplastic composition has a through plane thermal conductivity from about 0.45 W/mK to about 23 W/mK when determined in accordance with ASTM E1461.

Aspect 62. The composition of any of Aspects 1-57, wherein a molded sample of the blended thermoplastic composition has a through plane thermal conductivity from about 0.50 W/mK to about 20 W/mK when determined in accordance with ASTM E1461.

Aspect 63. The composition of any of Aspects 1-62, wherein a molded sample of the blended thermoplastic composition exhibits a plating index value of at least about 0.6.

Aspect 64. The composition of any of Aspects 1-62, wherein a molded sample of the blended thermoplastic composition exhibits a plating index value of at least about 0.7.

Aspect 65. The composition of any of Aspects 1-62, wherein a molded sample of the blended thermoplastic composition exhibits a plating index value from about 0.5 to about 1.5.

Aspect 66. The composition of any of Aspects 1-62, wherein a molded sample of the blended thermoplastic composition exhibits a plating index value from about 0.6 to about 1.2.

Aspect 67. The composition of any of Aspects 1-62, wherein a molded sample of the blended thermoplastic composition exhibits a plating index value from about 0.7 to about 1.9.

Aspect 68. A blended thermoplastic composition comprising: from about 50 wt % to about 95 wt % of a polyamide polymer; from about 4 wt % to about 49.95 wt % of a thermally conductive filler; and from about 0.05 wt % to about 20 wt % of a laser direct structuring additive; wherein the combined weight percent value of all components does not exceed about 100 wt %; wherein all weight percent values are based on the total weight of the composition; wherein a molded sample of the blended thermoplastic composition has a through plane thermal conductivity of at least about 0.40 W/mK when determined in accordance with ASTM E1461; and wherein a molded sample of the blended thermoplastic composition exhibits a plating index value of at least about 0.5.

Aspect 69. A blended thermoplastic composition comprising: a) from about 20 wt % to about 70 wt % of a polyamide polymer; b) from about 10 wt % to about 55 wt % of a thermally conductive filler; and c) from about 0.05 wt % to about 10 wt % of a laser direct structuring additive; wherein the combined weight percent value of all components does not exceed about 100 wt %; wherein all weight percent values are based on the total weight of the composition; wherein a molded sample of the blended thermoplastic composition has a through plane thermal conductivity of at least about 0.40 W/mK when determined in accordance with ASTM E1461; and wherein a molded sample of the blended thermoplastic composition exhibits a plating index value of at least about 0.5.

Aspect 70. A blended thermoplastic composition comprising: a) from about 30 wt % to about 60 wt % of a polyamide polymer; b) from about 10 wt % to about 40 wt % of a thermally conductive filler; and c) from about 1 wt % to about 5 wt % of a laser direct structuring additive; wherein the combined weight percent value of all components does not exceed about 100 wt %; wherein all weight percent values are based on the total weight of the composition; wherein a molded sample of the blended thermoplastic composition has a through plane thermal conductivity of at least about 0.40 W/mK when determined in accordance with ASTM E1461; and wherein a molded sample of the blended thermoplastic composition exhibits a plating index value of at least about 0.5.

Aspect 71. A blended thermoplastic composition comprising: a) from about 30 wt % to about 90 wt % of a polyamide polymer; b) from about 10 wt % to about 70 wt % of a thermally conductive filler; and c) from about 0.05 wt % to about 20 wt % of a laser direct structuring additive; wherein the combined weight percent value of all components does not exceed about 100 wt %; wherein all weight percent values are based on the total weight of the composition; wherein a molded sample of the blended thermoplastic composition has a through plane thermal conductivity of at least about 0.50 W/mK when determined in accordance with ASTM E1461; and wherein a molded sample of the blended thermoplastic composition exhibits a plating index value of at least about 0.7.

Aspect 72. A blended thermoplastic composition comprising: a) from about 20 wt % to about 70 wt % of a polyamide polymer; b) from about 10 wt % to about 55 wt % of a thermally conductive filler; and c) from about 0.05 wt % to about 10 wt % of a laser direct structuring additive; wherein the combined weight percent value of all components does not exceed about 100 wt %; wherein all weight percent values are based on the total weight of the composition; wherein a molded sample of the blended thermoplastic composition has a through plane thermal conductivity of at least about 0.50 W/mK when determined in accordance with ASTM E1461; and wherein a molded sample of the blended thermoplastic composition exhibits a plating index value of at least about 0.7.

Aspect 73. A blended thermoplastic composition comprising: a) from about 30 wt % to about 60 wt % of a polyamide polymer; b) from about 10 wt % to about 40 wt % of a thermally conductive filler; and c) from about 1 wt % to about 5 wt % of a laser direct structuring additive; wherein the combined weight percent value of all components does not exceed about 100 wt %; wherein all weight percent values are based on the total weight of the composition; wherein a molded sample of the blended thermoplastic composition has a through plane thermal conductivity of at least about 0.50 W/mK when determined in accordance with ASTM E1461; and wherein a molded sample of the blended thermoplastic composition exhibits a plating index value of at least about 0.7.

Aspect 74. An article comprising a composition of any of Aspects 1-73.

Aspect 75. The article of Aspect 74, wherein the article is a molded article.

Aspect 76. The article of Aspect 75, wherein the molded article is extrusion molded.

Aspect 77. The article of Aspect 75, wherein the molded article is injection molded.

Aspect 78. The article of any of Aspects 74-77, wherein the article is selected from a computer device, electromagnetic interference device, printed circuit, Wi-Fi device, Bluetooth device, GPS device, cellular antenna device, smart phone device, automotive device, medical device, sensor device, security device, shielding device, RF antenna device, LED device and RFID device.

Aspect 79. The article of any of Aspects 74-77, wherein the article is selected from a computer device, electromagnetic interference device, automotive device, medical device, sensor device, security device, shielding device, RF antenna device, LED device and RFID device.

Aspect 80. The article of any of Aspects 74-77, wherein the article is selected from a computer device, sensor device, security device, RF antenna device, LED device and RFID device.

Aspect 81. The article of any of Aspects 74-77, wherein the article is selected from a computer device, LED device and RFID device.

Aspect 82. The article of any of Aspects 74-77, wherein the article is a LED device.

Aspect 83. A method of improving thermal conductivity properties of a blended thermoplastic composition, the method comprising the step of combining: a) from about 30 wt % to about 90 wt % of at least one polymer component; b) from about 9 wt % to about 69.95 wt % of a thermally conductive filler; and c) from about 0.05 wt % to about 20 wt % of a laser direct structuring additive; wherein the combined weight percent value of all components does not exceed about 100 wt %; wherein all weight percent values are based on the total weight of the composition; wherein a molded sample of the blended thermoplastic composition has a through plane thermal conductivity of at least about 0.40 W/mK when determined in accordance with ASTM E1461; and wherein a molded sample of the blended thermoplastic composition exhibits a plating index value of at least about 0.5.

Aspect 84. The method of Aspect 83, wherein the polymer component is selected from a polypropylene, a polyethylene, an ethylene-based copolymer, a polycarbonate, a polyamide, a polyester, a polyoxymethylene (POM), a liquid crystal polymer (LPC), a polyphenylene sulfide (PPS), a polyphenylene ether (PPE), a polystyrene, a acrylonitrile-butadiene-styrene terpolymer, an acrylic polymer, a polyetherimide, a polyurethane, a polyethersulphone (PES), polyetheretherketone (PEEK), or combinations thereof.

Aspect 85. The method of Aspect 84, wherein the polyester is a terephthalate polyester.

Aspect 86. The method of Aspect 84, wherein the terephthalate polyester is selected from a polybutylene terephthalate, a polyethylene terephthalate, a polycyclohexylenedimethylene terephthalate, or combinations thereof.

Aspect 87. The method of Aspect 83, wherein the polyester comprises a blend of at least one polyphenylene oxide and at least one polystyrene.

Aspect 88. The method of Aspect 83, wherein the polymer component comprises a polyamide polymer.

Aspect 89. The method of Aspect 88, wherein the polyamide polymer is present in an amount from about 30 wt % to about 90 wt %.

Aspect 90. A method of improving thermal conductivity properties of a blended thermoplastic composition, the method comprising the step of combining: from about 50 wt % to about 95 wt % of a polyamide polymer; from about 4 wt % to about 49.95 wt % of a thermally conductive filler; and from about 0.05 wt % to about 20 wt % of a laser direct structuring additive; wherein the combined weight percent value of all components does not exceed about 100 wt %; wherein all weight percent values are based on the total weight of the composition; wherein a molded sample of the blended thermoplastic composition has a through plane thermal conductivity of at least about 0.40 W/mK when determined in accordance with ASTM E1461; and wherein a molded sample of the blended thermoplastic composition exhibits a plating index value of at least about 0.4.

Without further elaboration, it is believed that one skilled in the art can, using the description herein, utilize the present disclosure. The following examples are included to provide addition guidance to those skilled in the art of practicing the claimed disclosure. The examples provided are merely representative of the work and contribute to the teaching of the present disclosure. Accordingly, these examples are not intended to limit the disclosure in any manner.

While aspects of the present disclosure can be described and claimed in a particular statutory class, such as the system statutory class, this is for convenience only and one of skill in the art will understand that each aspect of the present disclosure can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present disclosure is not entitled to antedate such publication by virtue of prior disclosure. Further, the dates of publication provided herein can be different from the actual publication dates, which can require independent confirmation.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric. Unless indicated otherwise, percentages referring to composition are in terms of wt %.

There are numerous variations and combinations of reaction conditions, e.g., component concentrations, desired solvents, solvent mixtures, temperatures, pressures and other reaction ranges and conditions that can be used to optimize the product purity and yield obtained from the described process. Only reasonable and routine experimentation will be required to optimize such process conditions.

The materials shown in Table 1 were used to prepare the compositions described and evaluated herein. All samples were prepared by melt extrusion on a Toshiba Twin screw extruder, using different melt temperature and RPM according to different base resin. Tests were all conducted in accordance with ASTM standards, referenced in each test below.

The special gravity (“SG”) was determined in accordance with ASTM D792.

Melt Volume-flow Rate (“MVR”) was determined in accordance with ASTM D1238 under a load of 5.0 kg and at 275° C.

Izod impact strength was determined at 23° C. on 3.2 mm thick injection molded samples in accordance with ASTM D256 (notched Izod impact strength, “NII”), and in accordance with ASTM D4812 (unnotched Izod impact strength, “UII”).

Tensile testing was carried out at 5 mm/min at 23° C. on standard tensile injection molded bars in accordance with ASTM D638.

Flexural testing was carried out at 2.54 mm/min and 3.2 mm thick injection molded sample in accordance with ASTM D790.

Heat deflection temperature (“HDT” was determined at 1.82 MPa on injection molded samples (3.2 mm×12.5 mm bars) in accordance with ASTM D648.

Plating index was determined in accordance with ASTM B568 by testing the copper thickness using X-Ray Fluorescence (“XRF”). Briefly, LDS is carried out on molded plaques with laser power, frequency, and speed varied as indicated. A reference sample for XRF determinations was prepared using Pocan® DP 7102 with copper plating at about 5 p.m. Copper thickness was determined on the reference sample on both sides and at four discrete sample points. The copper thickness values were averaged for the reference sample and the average value is referred to X_{ref}. The plating index is defined by the following equation:

$$Plating index = \frac{Average copper thickness for one parameter field}{Average copper thickness for reference sick {X}_{ref}}$$

Thermal conductivity (“TC”) was conducted in accordance with ASTM E1461 measured using a Nanoflash LFA 447 xenon flash apparatus (Netzsch Group). The reference standard was pyroceram of similar thickness. Measurements are provided in units of κ (W/mK). The measurement determines the thermal diffusivity (α, cm²/s) and the specific heat (Cp, J/gK) of the sample, together with the density (ρ, g/cm³). Density was determined using a water immersion method (ASTM D792). The product of three values (α, ρ, and Cp) gives the thermal conductivity in the through plane according to the following equation:

κ=α(T)×Cp(T)×ρ(T).

TABLE 1

| Component | Chemical Description | Source |
|---|---|---|
| PA1 | Polyamide (PA66) resin | BASF Auxiliary |
| | | Chemicals Co. Ltd |
| PA2 | Polyamide (10,10) resin | Suzhou Hipro Polymers |
| | | Co., Ltd. |
| RA1 | N,N′-1,2-ethanediylbis-Octadecanamide | Lonza Group Ltd. |
| | (80~98 wt %), Stearic acid (<3%), Acrawax C | |
| | beads | |
| TS1 | Tris(2,4-ditert-butylphenyl) phosphite, | Ciba Specialty Chemicals |
| | stabilizer | |
| TS2 | N,N′-Hexane-1,6-diylbis[3-(3,5-di-tert-butyl- | Ciba Central Eastern |
| | 4-hydroxyphenylpropionamide], anti-oxidant | Europe Kft |
| CB1 | Pigment carbon black, powder | Cabot Specialty |
| | | Chemicals Inc. |
| MD1 | 2,2′-oxalyldiamidobis[ethyl 3-(3,5-di-tert- | Chemtura Europe Limited |
| | butyl-4-hydroxyphenyl)propionate], Metal | |
| | deactivator | |
| M1 | copper hydroxide phosphate | Sinopharm Chemical |
| | | Reagent Co., Ltd. |
| MS1 | Benzenepropanoic acid, 3,5-bis(1,1- | BASF Performance |
| | dimethylethyl)-4-hydroxy-, | Products Trading |
| | 2-[3-[3,5-bis(1,1-dimethylethyl)-4- | (Shanghai) Limited |
| | hydroxyphenyl]-1-oxopropyl]hydrazide, | |
| | copper stabilizer | |
| F1 | Hexagonal boron nitride | Dandong Chemical |
| | | Engineering Institute Co., |
| | | Ltd. |
| F2 | Aminosilane-treated magnesium hydroxide | Martinswerk GmbH |
| F3 | Asbury graphite | Asbury Graphite Mills, |
| | | Inc. |

The materials used in preparing the samples are listed in Table 1 and were prepared using a Twin screw extruder (Toshiba TEM-37BS, L/D=40.5) with the temperature of the extruder barrel set at 260° C. Pellets extruded from the extruder were then injection molded into 80×10×3 mm bar, cut into 10×10×3 mm square sample for through plane thermal conductivity measurement, Φ100×0.4 mm sheet and cut into Φ25×0.4 mm round sample for in plane thermal conductivity measurement.

Exemplary formulations #1-7 are shown in Table 2, using the materials shown in Table 1. All materials are provided in wt % wherein all weight percent values are based on the total weight of the given formulation. The compounding profile for the preparation of the various formulations shown in Table 2 is given in Table 3, while the molding profile used to prepare molded samples from the formulations is given in Table 4. Molded samples were prepared using these formulations and characterized by various tests described herein above, with the results shown in Table 5.

TABLE 2

| Component | 1 | 2 | 3 | 4 | 5 | 6 | 7 |
|---|---|---|---|---|---|---|---|
| PA1 | 85.9 | 58.9 | 55.9 | 58.9 | 55.9 | 58.9 | 55.9 |
| PA2 | 10 | 10 | 10 | 10 | 10 | 10 | 10 |
| RA1 | 0.2 | 0.2 | 0.2 | 0.2 | 0.2 | 0.2 | 0.2 |
| TS1 | 0.15 | 0.15 | 0.15 | 0.15 | 0.15 | 0.15 | 0.15 |
| TS2 | 0.2 | 0.2 | 0.2 | 0.2 | 0.2 | 0.2 | 0.2 |
| CB1 | 0.3 | 0.3 | 0.3 | 0.3 | 0.3 | 0.3 | 0.3 |
| MD1 | 0.2 | 0.2 | 0.2 | 0.2 | 0.2 | 0.2 | 0.2 |
| M1 | 3 | | 3 | | 3 | | 3 |
| MS1 | 0.1 | 0.1 | 0.1 | 0.1 | 0.1 | 0.1 | 0.1 |
| F1 | | 30 | 30 | | | | |
| F2 | | | | 30 | 30 | | |
| F3 | | | | | | 30 | 30 |
| Formulation Total | 100 | 100 | 100 | 100 | 100 | 100 | 100 |

TABLE 3

| Parameters | UOM | Value |
|---|---|---|
| Compounder Type | None | Toshiba TEM-37BS |
| Barrel Size | mm | 1500 |
| Die | mm | 3 |
| Zone 1 Temp | ° C. | 100 |
| Zone 2 Temp | ° C. | 150 |
| Zone 3 Temp | ° C. | 200 |
| Zone 4 Temp | ° C. | 255 |
| Zone 5 Temp | ° C. | 255 |
| Zone 6 Temp | ° C. | 255 |
| Zone 7 Temp | ° C. | 255 |
| Zone 8 Temp | ° C. | 255 |
| Zone 9 Temp | ° C. | 255 |
| Zone 10 Temp | ° C. | 255 |
| Zone 11 Temp | ° C. | 255 |
| Die Temp | ° C. | 260 |
| Screw speed | rpm | 350 |
| Throughput | kg/hr | 50 |
| Vacuum | MPa | −0.08 |
| Side Feeder speed | Rpm | 300 |
| Side feeder1 | Note | barrel 7 |

TABLE 4

| Parameter | Unit | Value |
|---|---|---|
| Pre-drying time | Hour | 4 |
| Pre-drying temperature | ° C. | 85 |
| Hopper temp | ° C. | 50 |
| Zone 1 temp | ° C. | 275 |
| Zone 2 temp | ° C. | 280 |
| Zone 3 temp | ° C. | 280 |
| Nozzle temp | ° C. | 280 |
| Mold temp | ° C. | 90 |
| Screw speed | rpm | 80 |
| Back pressure | kgf/cm² | 30 |
| Cooling time | s | 15 |
| Injection speed | mm/s | 60 |
| Holding pressure | kgf/cm² | 800 |
| Max. Injection pressure | kgf/cm² | 1000 |

The effect of LDS additives and different kinds of thermally conductive fillers on the mechanical properties and plating performance of PA66 base resin is shown in Table 5. In the thermal conductivity test, pellets from the extruder were then injection molded into a 80*10*3 mm bar and cut into 10*10*3 mm square sample for through plane thermal conductivity measurement.

The performance comparison of different kinds of thermally conductive fillers including graphite, magnesium hydroxide and BN with/without 3% LDS additive in PA composites is also given in Table 5. As can be seen, all the samples with 3% LDS additive (Formulations #3, #5 and #7) have similar mechanical properties and thermal conductivity when compared to samples without LDS additive (Formulations #2, #4 and 6#), indicating that these materials can be used as thermally conductive plastics composites. For plating index, Formulation #3 with the addition of 30% BN has higher PI values when compared with samples with 30% magnesium hydroxide and graphite as compared to control samples without thermally conductive fillers. Importantly, the addition of BN and magnesium hydroxide have synergistic effects with the LDS additive on plating performance of composites, as verified by plating index. As such, the addition of an LDS additive yields successful laser direct structuring.

In summary, by adding a LDS additive to thermally conductive polymer compositions, the compositions are thermally conductive materials which provide solutions to a variety of electrical, electronic and thermal design problems throughout industry, which can undergo laser structuring and chemical plating to etch circuit patterns on molded polymer components and metalize the circuits in the areas activated by the laser.

TABLE 5

| Test Description | Unit | #1 | #2 | #3 | #4 | #5 |
|---|---|---|---|---|---|---|
| MVR-Avg (275C/5 kg) | cm³/10 min | 197 | 73.8 | 194 | 89.6 | 99.5 |
| Modulus of Elasticity - | MPa | 3321 | 6468 | 6856 | 4725 | 4792 |
| Avg | | | | | | |
| Stress at Break - Avg | MPa | 70.2 | 55.4 | 53.6 | 73.1 | 71.4 |
| Elongation at Break - | % | 3.1 | 2.7 | 2.3 | 2.9 | 2.9 |
| Avg | | | | | | |
| Flexural Modulus - Avg | MPa | 2390 | 6080 | 6500 | 3570 | 3730 |
| Flex Stress @ 5% | MPa | 99.1 | 0 | 0 | 92.9 | 93.6 |
| Strain - Avg | | | | | | |
| Flexural Stress @ Yield - | MPa | 104 | 101 | 93.6 | 118 | 118 |
| Avg | | | | | | |
| Flexural Stress @ | MPa | 103 | 101 | 93.4 | 118 | 118 |
| Break - Avg | | | | | | |
| Impact Strength - Avg | J/m | 30.5 | 29.8 | 20.1 | 33.4 | 30.7 |
| (notched) | | | | | | |
| Impact Strength - Avg | J/m | 223 | 293 | 278 | 602 | 587 |
| (unnotched) | | | | | | |
| Deflection temp - Avg | ° C. | 74.4 | 155 | 166 | 85.2 | 91.5 |
| Density - Avg | — | 1.158 | 1.318 | 1.354 | 1.323 | 1.360 |
| Thermal conductivity | W/(m · K) | 0.45 | 1.1 | 1.2 | 0.65 | 0.65 |
| Plating index | — | 0.63 | — | 0.83 | — | 0.69 |

| Test Description | Unit | #6 | #7 |
|---|---|---|---|
| MVR-Avg (275C/5 kg) | cm³/10 min | 66.1 | 50.2 |
| Modulus of Elasticity - | MPa | 6314 | 6385 |
| Avg | | | |
| Stress at Break - Avg | MPa | 56.9 | 54.6 |
| Elongation at Break - | % | 2 | 1.9 |
| Avg | | | |
| Flexural Modulus - Avg | MPa | 6020 | 6210 |
| Flex Stress @ 5% | MPa | 0 | 0 |
| Strain - Avg | | | |
| Flexural Stress @ Yield - | MPa | 91.5 | 91.3 |
| Avg | | | |
| Flexural Stress @ | MPa | 91.3 | 91.2 |
| Break - Avg | | | |
| Impact Strength - Avg | J/m | 25.9 | 22.4 |
| (notched) | | | |
| Impact Strength - Avg | J/m | 208 | 158 |
| (unnotched) | | | |
| Deflection temp - Avg | ° C. | 171 | 169 |
| Density - Avg | — | 1.328 | 1.359 |
| Thermal conductivity | W/(m · K) | 1.3 | 1.4 |
| Plating index | — | — | 0.49 |

The patentable scope of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A blended thermoplastic composition comprising:
a. from about 30 wt % to about 90 wt % of at least one polymer component;
b. from about 9 wt % to about 69.95 wt % of a thermally conductive filler; and
c. from about 0.05 wt % to about 20 wt % of a laser direct structuring additive;
wherein the combined weight percent value of all components does not exceed about 100 wt %;
wherein all weight percent values are based on the total weight of the composition;
wherein a molded sample of the blended thermoplastic composition has a through plane thermal conductivity of at least about 0.40 W/mK when determined in accordance with ASTM E1461; and
wherein a molded sample of the blended thermoplastic composition exhibits a plating index value of at least about 0.5.

2. The blended thermoplastic composition of claim 1, wherein the polymer component comprises a polypropylene, a polyethylene, an ethylene-based copolymer, a polycarbonate, a polyamide, a polyester, a polyoxymethylene, a liquid crystal polymer, a polyphenylene sulfide, a polyphenylene ether, a polystyrene, a acrylonitrile-butadiene-styrene terpolymer, an acrylic polymer, a polyetherimide, a polyurethane, a polyethersulphone, or a polyetheretherketone, or combinations thereof.

3. The blended thermoplastic composition of claim 1, wherein the polymer component comprises a terephthalate polyester.

4. The blended thermoplastic composition of claim 3, wherein the terephthalate polyester comprises a polybutylene terephthalate, a polyethylene terephthalate, or a polycyclohexylenedimethylene terephthalate, or combinations thereof.

5. The blended thermoplastic composition of claim 1, wherein the polymer component comprises a blend of at least one polyphenylene oxide and at least one polystyrene.

6. The blended thermoplastic composition of claim 1, wherein the polymer component is a polyamide polymer.

7. The blended thermoplastic composition of claim 6, wherein the polyamide polymer comprises polyamide-4; polyamide-4,6; polyamide-4,9; polyamide-6; polyamide-6,6; polyamide 6,9; polyamide-6,10; polyamide-6,12; polyamide 10; polyamide 10,10; polyamide 10,12; polyamide 11; polyamide-12; polyamide 12,12; amorphous polyamide resins; polyamide PPA; polyamide 4T; polyamide 6T; polyamide 6/6T; or polyamide 6,6/6T; polyamide 9T; or combinations thereof.

8. The blended thermoplastic composition of claim 6, wherein the polyamide polymer comprises polyamide 4,6; polyamide 6; polyamide 6,6; polyamide 6,12; polyamide 10, or polyamide 10,10; or combinations thereof.

9. The blended thermoplastic composition of claim 6, wherein the polyamide polymer comprises polyamide 9T, polyamide 6; polyamide 6,6; or polyamide 10,10; or combinations thereof.

10. The blended thermoplastic composition of claim 6, wherein the polyamide polymer comprises a first polyamide polymer and a second polyamide polymer; wherein the first polyamide polymer comprises polyamide 6 and polyamide 6,6; and wherein the second polyamide polymer is selected from polyamide 10,10; polyamide 10,12; or polyamide 12,12; or combinations thereof.

11. The blended thermoplastic composition of claim 6, wherein the polyamide polymer is present in an amount from about 30 wt % to about 70 wt %.

12. The blended thermoplastic composition of claim 1, wherein the thermally conductive filler is a high thermally conductive filler having a thermal conductivity greater than or equal to about 50 W/mK; or a low thermally conductive filler having a thermal conductivity from about 10 W/mK to about 30 W/mK; or a combinations thereof.

13. The blended thermoplastic composition of claim 12, wherein the high thermally conductive filler comprises AlN, Al₄C₃, Al₂O₃, BN, AlON, MgSiN₂, SiC, Si₃N₄, graphite, expanded graphite, graphene, or carbon fiber, or combinations thereof.

14. The blended thermoplastic composition of claim 12, wherein the high thermally conductive filler comprises BN, graphite, or expanded graphite, or combinations thereof.

15. The blended thermoplastic composition of claim 12, wherein the low thermally conductive filler comprises ZnS, CaO, MgO, ZnO, or TiO₂, or combinations thereof.

16. The blended thermoplastic composition of claim 1, wherein the thermally conductive filler is present in an amount from about 10 wt % to about 60 wt %.

17. The blended thermoplastic composition of claim 1, wherein the thermally conductive filler is present in an amount from about 20 wt % to about 50 wt %.

18. The blended thermoplastic composition of claim 1, further comprising a thermally insulating filler.

19. The blended thermoplastic composition of claim 18, wherein the thermally insulating filler has a conductivity of less than or equal to about 10 W/mK.

20. The blended thermoplastic composition of claim 18, wherein the thermally insulating filler comprises Mg(OH)₂, CaCO₃, mica, γ-AlO(OH), BaO, BaSO₄, AlO(OH), CaSiO₃, ZrO₂, SiO₂, glass beads, glass fiber, H₂Mg₃(SiO₃)₄, AL(OH)₃, MgO.xAl₂O₃, CaMg(CO₃)₂, ceramic-coated graphite, or clay, or combinations thereof.

21. The blended thermoplastic composition of claim 1, wherein the laser direct structure additive comprises a metal oxide or a metal oxide-coated filler, or a combination thereof.

22. The blended thermoplastic composition of claim 1, wherein the laser direct structure additive is a metal oxide comprising a copper-containing metal oxide, a titanium-containing metal oxide, a tin-containing metal oxide, a zinc-containing metal oxide, a magnesium-containing metal oxide, an aluminum-containing metal oxide, a gold-containing metal oxide, or a silver-containing metal oxide, or a combination thereof.

23. The blended thermoplastic composition of claim 1, wherein the laser direct structure additive is a metal-oxide coated filler comprising a mineral substrate and a coating comprising an antimony doped tin oxide, a copper-containing metal oxide, a zinc-containing metal oxide, a tin-containing metal oxide, a magnesium-containing metal oxide, an aluminum-containing metal oxide, a gold-containing metal oxide, or a silver-containing metal oxide, or a combination thereof.

24. The blended thermoplastic composition of claim 1, wherein the laser direct structure additive is present in an amount from about 0.5 wt % to about 70 wt %.

25. The blended thermoplastic composition of any of claims 1—Error! Reference source not found., wherein the laser direct structure additive is present in an amount from about 0.5 wt % to about 60 wt %.

26. The blended thermoplastic composition of any of claims 1—Error! Reference source not found., wherein the laser direct structure additive is present in an amount from about 0.5 wt % to about 50 wt %.

27. The blended thermoplastic composition of claim 1, further comprising a flame retardant.

28. The blended thermoplastic composition of claim 27, wherein the flame retardant is a phosphorous-containing flame retardant comprising a phosphine, a phosphine oxide, a bisphosphine, a phosphonium salt, a phosphinic acid salt, a phosphoric ester, or a phosphorous ester, or a combination thereof.

29. The blended thermoplastic composition of claim 1, further comprising an additive comprising an antioxidant, a lubricant, a thermal stabilizer, an ultraviolet light absorbing additive, a plasticizer, an anti-dripping agent, a mold release agent, an antistatic agent, a dye, a pigment, or a radiation stabilizer, or a combination thereof.

30. The blended thermoplastic composition of claim 1, wherein a molded sample of the blended thermoplastic composition has a through plane thermal conductivity of at least about 0.45 W/mK when determined in accordance with ASTM E1461.

31. The blended thermoplastic composition of claim 1, wherein a molded sample of the blended thermoplastic composition has a through plane thermal conductivity of at least about 0.50 W/mK when determined in accordance with ASTM E1461.

32. The blended thermoplastic composition of claim 1, wherein a molded sample of the blended thermoplastic composition has a through plane thermal conductivity from about 0.40 W/mK to about 25 W/mK when determined in accordance with ASTM E1461.

33. The blended thermoplastic composition of claim 1, wherein a molded sample of the blended thermoplastic composition exhibits a plating index value of at least about 0.6.

34. The blended thermoplastic composition of claim 1, wherein a molded sample of the blended thermoplastic composition exhibits a plating index value from about 0.5 to about 1.9.

35. An article comprising a composition of claim 1.

36. The article of claim 35, wherein the article is selected from a computer device, electromagnetic interference device, printed circuit, Wi-Fi device, Bluetooth device, GPS device, cellular antenna device, smart phone device, automotive device, medical device, sensor device, security device, shielding device, RF antenna device, LED device and RFID device.

37. A blended thermoplastic composition comprising:
a. from about 50 wt % to about 95 wt % of a polyamide polymer;
b. from about 4 wt % to about 49.95 wt % of a thermally conductive filler; and
c. from about 0.05 wt % to about 20 wt % of a laser direct structuring additive;
wherein the combined weight percent value of all components does not exceed about 100 wt %;
wherein all weight percent values are based on the total weight of the composition;
wherein a molded sample of the blended thermoplastic composition has a through plane thermal conductivity of at least about 0.40 W/mK when determined in accordance with ASTM E1461; and
wherein a molded sample of the blended thermoplastic composition exhibits a plating index value of at least about 0.4.

38. A method of improving thermal conductivity properties of a blended thermoplastic composition, the method comprising the step of combining:
a. from about 30 wt % to about 90 wt % of a polymer component;
b. from about 9 wt % to about 69.95 wt % of a thermally conductive filler; and
c. from about 0.05 wt % to about 20 wt % of a laser direct structuring additive;
wherein the combined weight percent value of all components does not exceed about 100 wt %;
wherein all weight percent values are based on the total weight of the composition;
wherein a molded sample of the blended thermoplastic composition has a through plane thermal conductivity of at least about 0.40 W/mK when determined in accordance with ASTM E1461; and
wherein a molded sample of the blended thermoplastic composition exhibits a plating index value of at least about 0.5.

39. The method of claim 38, wherein the polymer component comprises a polypropylene, a polyethylene, an ethylene-based copolymer, a polycarbonate, a polyamide, a polyester, a polyoxymethylene, a liquid crystal polymer, a polyphenylene sulfide, a polyphenylene ether, a polystyrene, a acrylonitrile-butadiene-styrene terpolymer, an acrylic polymer, a polyetherimide, a polyurethane, a polyethersulphone, or a polyetheretherketone, or combinations thereof.

40. A method of improving thermal conductivity properties of a blended thermoplastic composition, the method comprising the step of combining:
a. from about 50 wt % to about 95 wt % of a polyamide polymer;
b. from about 4 wt % to about 49.95 wt % of a thermally conductive filler; and
c. from about 0.05 wt % to about 20 wt % of a laser direct structuring additive;
wherein the combined weight percent value of all components does not exceed about 100 wt %;
wherein all weight percent values are based on the total weight of the composition;
wherein a molded sample of the blended thermoplastic composition has a through plane thermal conductivity of at least about 0.40 W/mK when determined in accordance with ASTM E1461; and
wherein a molded sample of the blended thermoplastic composition exhibits a plating index value of at least about 0.4.
